(19) United States
(12) Patent Application Publication
(10) Pub. No.: US 2019/0047469 A1
(43) Pub. Date: Feb. 14, 2019

(54) VEHICLE CONTROL SYSTEM AND VEHICLE CONTROL METHOD

(71) Applicant: HONDA MOTOR CO., LTD., Tokyo (JP)

(72) Inventors: Haruhiko Nishiguchi, Wako-shi (JP); Hiroyuki Koibuchi, Wako-shi (JP)

(21) Appl. No.: 16/059,071

(22) Filed: Aug. 9, 2018

(30) Foreign Application Priority Data
Aug. 14, 2017 (JP) 2017-156433

(51) Int. Cl. B60Q 1/34; B62D 15/02

(52) U.S. Cl. CPC B60Q 1/346; B62D 15/0255

(57) ABSTRACT

A vehicle control system includes a receiver which receives an operation of an occupant of a vehicle and, according to the received operation, changes to any one of a plurality of states including a first state before an operation is received and a second state after the operation is received, a direction indicator which is actuated when the receiver has changed to the second state, and a lane change controller which executes lane change control for changing lanes of the vehicle to other lanes independently of a steering operation of the occupant of the vehicle according to change of the receiver from the first state to the second state, wherein the lane change controller continuously actuates the direction indicator until the execution situation of the lane change control becomes a predetermined situation even after the receiver has changed from the second state to the first state when the lane change control is executed.

### CROSS-REFERENCE TO RELATED APPLICATIONS

This application is based upon and claims the benefit of priority from Japanese Patent Application No. 2017-156433, filed Aug. 14, 2017; the entire contents all of which are incorporated herein by reference.

### BACKGROUND OF THE INVENTION

### Field of the Invention

The present invention relates to a vehicle control system and a vehicle control method.

### Description of Related Art

Conventionally, a technology for performing lane change when an operation of a direction indicator switch is detected is known (refer to Japanese Unexamined Patent Application, First Publication No. 2012-226392, for example).

### SUMMARY OF THE INVENTION

However, there are cases in which a time at which a direction indicator is operated is not appropriate when lane change is performed in the conventional technology.

An object of embodiments of the present invention devised in view of the aforementioned circumstances is to provide a vehicle control system and a vehicle control method capable of operating a direction indicator at an appropriate time when lanes are changed.

A vehicle control system and a vehicle control method according to the present invention employ configurations below.

(1) One aspect of the present invention is a vehicle control system including: a receiver which receives an operation of an occupant of a vehicle and, according to the received operation, changes to any one of a plurality of states including a first state before an operation is received and a second state after the operation is received; a direction indicator which is actuated when the receiver has changed to the second state; and a lane change controller which executes lane change control for changing lanes of the vehicle to other lanes independently of a steering operation of the occupant of the vehicle according to change of the receiver from the first state to the second state, wherein the lane change controller continuously actuates the direction indicator until the execution situation of the lane change control becomes a predetermined situation even after the receiver has changed from the second state to the first state when the lane change control is executed.

(2) The lane change controller further determines an actuation time of the direction indicator after the receiver has changed from the second state to the first state on the basis of the execution situation of the lane change control in the vehicle control system of the aspect (1).

(3) The direction indicator is continuously actuated while the receiver is in the second state and is not actuated when the receiver changes from the second state to the first state in the vehicle control system of the aspect (1) or (2).

(4) The direction indicator is continuously actuated for a predetermined time even after the receiver has changed to the first state from the second state in the vehicle control system of any one of the aspects (1) to (3).

(5) The lane change controller continuously actuates the direction indicator until the vehicle arrives at a predetermined position which is a lane change destination or a time necessary for the vehicle to arrive at a predetermined position which is a lane change destination elapses even after the receiver has changed to the first state from the second state in the vehicle control system of any one of the aspects (1) to (4).

(6) When the receiver which has changed to the second state from the first state is maintained in the second state for a first predetermined time or longer, the lane change controller continuously actuates the direction indicator until the execution situation of the lane change control becomes a predetermined situation even after the receiver has changed to the first state from the second state in the vehicle control system of any one of the aspects (1) to (5).

(7) When the receiver which has been in the second state for the first predetermined time or longer changes to the second state again after changing to the first state from the second state and lane change control expected to be started according to the first change to the second state of the receiver has not been executed yet, the lane change controller stops the expected lane change control without starting the expected lane change control in the vehicle control system of the aspect (6).

(8) When the receiver which has been in the second state for the first predetermined time or longer changes to the second state again after changing to the first state from the second state and the lane change control has already been executed according to the first change to the second state of the receiver, the lane change controller further stops the lane change control being executed if the vehicle does not cross a dividing line dividing a lane of a lane change destination and a lane before lane change in the vehicle control system of the aspect (6) or (7).

(9) The second state includes a third state in which a direction indicator provided on the left side when viewed in the advancing direction of the vehicle is actuated and a fourth state in which a direction indicator provided on the right side when viewed in the advancing direction of the vehicle is actuated, and the lane change controller stops the lane change control when the receiver has changed to the fourth state after changing to the first state from the third state or the receiver has changed to the third state after changing to the first state from the fourth state in the vehicle control system of any one of the aspects (6) to (8).

(10) Another aspect of the present invention is a vehicle control method which causes a computer mounted in a vehicle including a receiver which receives an operation of an occupant and, according to the received operation, changes to any one of a plurality of states including a first state before an operation is received and a second state after the operation is received and a direction indicator which is actuated when the receiver has changed to the second state to execute lane change control for changing lanes of the vehicle to other lanes independently of a steering operation of the occupant of the vehicle according to change of the receiver from the first state to the second state and to continuously actuate the direction indicator until the execution situation of the lane change control becomes a predetermined situation even after the receiver has changed from the second state to the first state when the lane change control is executed.

According to the aspects of (1) to (4) and (10), it is possible to actuate a direction indicator at an appropriate time when lane change is performed.

According to the aspect (5), the occupant need not stop a direction indicator when actuation of the direction indicator is not stopped irrespective of completion of lane change. As a result, it is possible to eliminate a burden on the occupant in stopping of the direction indicator.

According to the aspect (6), it is possible to prevent lane change from being started when the receiver has changed to the second state due to an erroneous operation of the occupant and the like.

According to the aspects (7), (8) and (9), when the receiver in the second state has changed to the first state and then changed to the second state again, lane change control is stopped. Accordingly, it is possible to perform lane change in which an intention of the occupant is accurately reflected.

### BRIEF DESCRIPTION OF THE DRAWINGS

FIG. 1 is a block diagram of a vehicle control system of an embodiment.

FIG. 2 is a diagram describing positions of a turn signal lever.

FIG. 3 is a diagram showing a state in which a relative position and an attitude of a subject vehicle with respect to a traveling lane are recognized by a vehicle position recognizer.

FIG. 4 is a diagram schematically showing a state in which a lane change target position is set in a neighboring lane.

FIG. 5 is a diagram showing a situation in which automatic lane change assistance control is performed together with a timing chart showing a timing of each control.

FIG. 6 is a diagram describing a target position of a neighboring lane which is a lane change destination.

FIG. 7 is a diagram showing a situation in which automatic lane change assistance control is not performed together with a timing chart showing a timing of each control.

FIG. 8 is a diagram showing a situation in which automatic lane change assistance control is not performed together with a timing chart showing a timing of each control.

FIG. 9 is a diagram showing a situation in which automatic lane change assistance control is not performed together with a timing chart showing a timing of each control.

FIG. 10 is a diagram showing a situation in which automatic lane change assistance control is performed together with a timing chart showing a timing of each control.

FIG. 11 is a diagram showing a situation in which automatic lane change assistance control is not performed together with a timing chart showing a timing of each control.

FIG. 12 is a diagram showing a situation in which automatic lane change assistance control is not performed together with a timing chart showing a timing of each control.

FIG. 13 is a flowchart showing a series of processes performed by a master controller and a driving assistance controller in an embodiment.

FIG. 14 is a diagram showing an example of a screen displayed on a display device of an HMI during standby for lane change.

FIG. 15 is a diagram showing an example of a screen displayed on the display device of the HMI during time out.

FIG. 16 is a diagram showing an example of a screen displayed on the display device of the HMI when automatic lane change assistance control starts.

FIG. 17 is a diagram showing a situation in which automatic lane change assistance control is performed together with a timing chart showing a timing of each control.

FIG. 18 is a diagram showing a situation in which automatic lane change assistance control is not performed together with a timing chart showing a timing of each control.

FIG. 19 is a flowchart showing another example of a series of processes performed by the master controller and the driving assistance controller (1).

FIG. 20 is a flowchart showing another example of a series of processes performed by the master controller and the driving assistance controller (2).

### DETAILED DESCRIPTION OF THE INVENTION

Hereinafter, embodiments of a vehicle control system and a vehicle control method of the present invention will be described with reference to the drawings.

### Overall Configuration

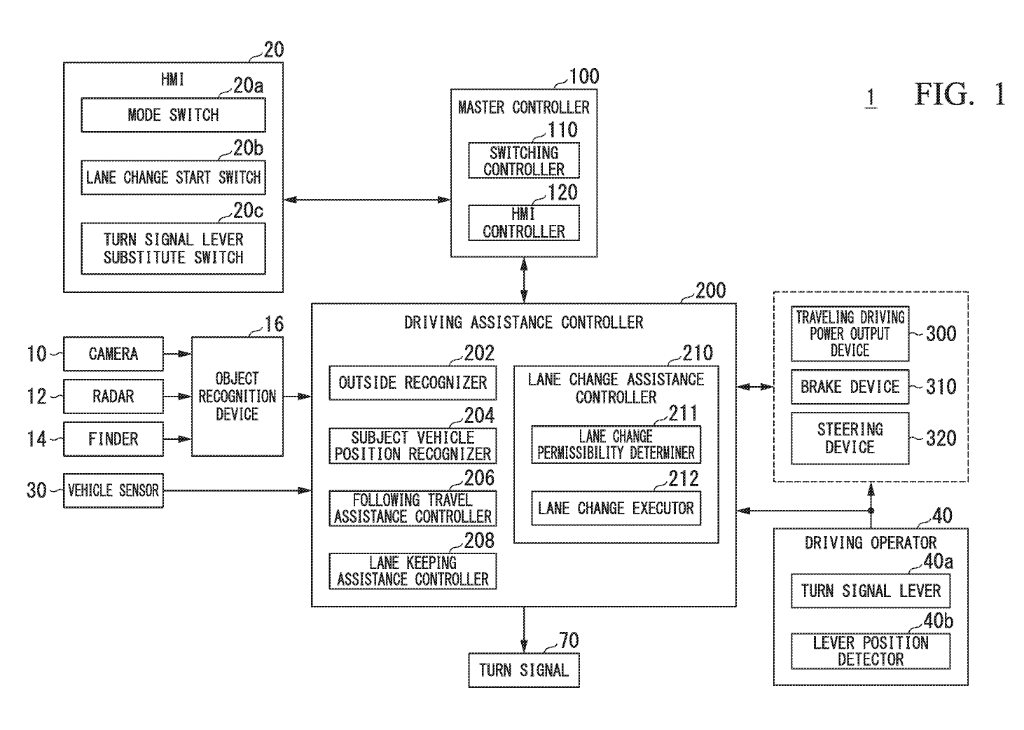

FIG. 1 is a block diagram of a vehicle control system 1 of an embodiment. For example, a vehicle (hereinafter referred to as a subject vehicle M) in which the vehicle control system 1 is mounted is a two-wheeled vehicle, a three-wheeled vehicle, a four-wheeled vehicle or the like and a driving source thereof is an internal combustion engine such as a diesel engine or a gasoline engine, a motor or a combination thereof. A motor operates using power generated by a generator connected to an internal combustion engine or discharged power of a secondary battery or a fuel cell.

For example, the vehicle control system 1 includes a camera 10, a radar 12, a finder 14, an object recognition device 16, a human machine interface (HMI) 20, a vehicle sensor 30, a driving operator 40, a turn signal (direction indicator) 70, a master controller 100, a driving assistance controller 200, a traveling driving power output device 300, a brake device 310, and a steering device 320. These devices and apparatuses are connected through a multi-communication line such as a controller area network (CAN) communication line, a serial communication line, a wireless communication network or the like. The configuration shown in FIG. 1 is an example and some of the components may be omitted or other components may be added.

For example, the camera 10 is a digital camera using a solid-state image sensing device such as a charge-coupled device (CCD) and a complementary metal-oxide semiconductor (CMOS). One or more cameras 10 are attached to any points on the subject vehicle M. When a front view image is captured, the camera 10 is attached to the upper part of the front windshield, the back side of a rear-view mirror, or the like. For example, the camera 10 periodically repeatedly photographs the surroundings of the subject vehicle M. The camera 10 may be a stereo camera.

The radar 12 radiates radio waves such as millimeter waves to the surroundings of the subject vehicle M and detects radio waves (reflected waves) reflected by an object to detect at least the position (distance and orientation) of the object. One or more radars 12 are attached to any points on the subject vehicle M. The radar 12 may detect the position and speed of an object through a frequency-modulated continuous wave (FM-CW) method.

The finder 14 is a light detection and ranging or laser imaging detection and ranging (LIDAR) finder for measuring scattering light with respect to radiated light to detect a distance to a target. One or more finders 14 are attached to any points on the subject vehicle M.

The object recognition device 16 performs sensor fusion processing on detection results of some or all of the camera 10, the radar 12 and the finger 14 to recognize positions, types, speed, movement directions and the like of objects. For example, the recognized objects may be types of object such as a vehicle, a guard rail, an electricity pole, a pedestrian and a traffic sign. The object recognition device 16 outputs recognition results to the driving assistance controller 200. In addition, the object recognition device 16 may output some of the information input from the camera 10, the radar 12 or the finder 14 to the driving assistance controller 200 as it is.

The HMI 20 displays various types of information to an occupant of the subject vehicle M and receives an input operation of the occupant. For example, the HMI 20 includes various display devices such as a liquid crystal display (LCD) and an organic electroluminescence (EL) display, various switches such as a mode switch 20a, a lane change start switch 20b and a turn signal lever substitute switch 20c, a speaker, a buzzer, a touch panel and the like. Each apparatus of the HMI 20 is attached to one part of an installment panel and any point on the assistant driver's seat or the back seat, for example.

The mode switch 20a is a switch for switching between a driving assistance mode and a manual driving mode, for example. The driving assistance mode is a mode in which any one or both of the traveling driving power output device 300 and the brake device 310, and the steering device 320 are controlled by the driving assistance controller 200, for example. The manual driving mode is a mode in which the traveling driving power output device 300, the brake device 310 and the steering device 320 are controlled according to an operation quantity of the driving operator 40.

The lane change start switch 20b is a switch for causing the subject vehicle M to start steering assistance control for changing lanes independently of a steering wheel operation of the occupant in the driving assistance mode.

The turn signal substitute switch 20c is a switch for turning on or blinking the turn signal 70 while an operation from the occupant is received, for example. In addition, the turn signal lever substitute switch 20c may be a switch for turning on or blinking the turn signal 70 until a predetermined time elapses from when an operation from the occupant is received or a switch for blinking the turn signal 70 a predetermined number of times after an operation from the occupant is received, for example. The turn signal lever substitute switch 20c is an example of a “receiver.”

For example, the vehicle sensor 30 includes a vehicle speed sensor for detecting the speed of the subject vehicle M, an acceleration sensor for detecting an acceleration, a yaw rate sensor for detecting an angular velocity around a vertical axis, a direction sensor for detecting a direction of the subject vehicle M, and the like. Each sensor included in the vehicle sensor 30 outputs a detection signal indicating a detection result to the driving assistance controller 200.

The driving operator 40 includes various operators such as the aforementioned steering wheel, a turn signal lever (direction indication switch) 40a, an accelerator pedal, a brake pedal and a shift lever, for example. The turn signal lever 40a switches between actuation and deactivation of the turn signal 70. For example, a detector for detecting an operation quantity of an operation of the occupant is attached to each operator of the driving operator 40. For example, a lever position detector 40b is provided in the turn signal lever 40a. The lever position detector 40b detects a position of the turn signal lever 40a. In addition, a detector provided in the accelerator pedal or the brake pedal detects a depression amount of the pedal and a detector provided in the steering wheel detects a steering angle, a steering torque and the like of the steering wheel. In addition, each detector (also including the lever position detector 40b) outputs a detection signal indicating detection results to one or both of the driving assistance controller 200 and a combination of the traveling driving power output device 300 and a combination of the brake device 310 and the steering device 320. The turn signal lever 40a is another example of a “receiver.”

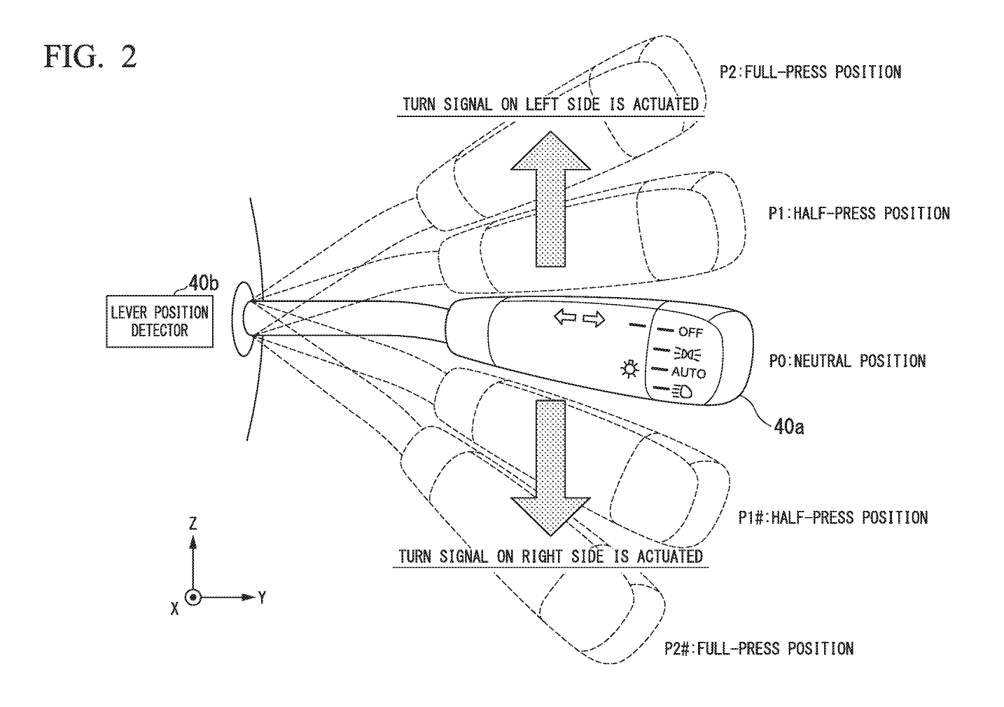

FIG. 2 is a diagram describing positions of the turn signal lever 40a. In the figure, X represents an advancing/reversing direction of the subject vehicle M, Y represents a width direction of the subject vehicle M, and Z represents a vertical direction of the subject vehicle M. For example, one end of the turn signal lever 40a is supported at a certain point. When the turn signal lever 40a receives an operation of an occupant, the turn signal lever 40a rotates with the point at which one end thereof is supported as a start point in the vertical direction (Z direction).

In the example, when the turn signal lever 40a is turned upward to be shifted to a half-press position P1 or a full-press position P2 with respect to a neutral position P0, the turn signal 70 of the left side of the subject vehicle M is actuated. “Actuation” refers to an operation of turning on or blinking a light (turn light) functioning as the turn signal 70.

The neutral position P0 is a position at which the turn signal 70 is not actuated and this position is maintained when the turn signal lever 40a is not operated. A state in which the turn signal lever 40a is positioned at the neutral position P0 is an example of a “first state.”

The half-press position P1 is a position at which the turn signal 70 on the left side of the subject vehicle M is actuated and this position is maintained while the turn signal lever 40a is operated. The position of the turn signal lever 40a shifts to the neutral position P0 at a timing at which the turn signal lever 40a is not operated. For example, the turn signal 70 on the left side is actuated when the occupant presses the turn signal lever 40a with a hand to the half-press position P1 and, when the occupant releases the hand in this state, the turn signal lever 40a shifts to the neutral position P0 by itself and thus the actuated turn signal 70 on the left side is stopped.

The full-press position P2 is a position at which the turn signal 70 on the left side of the subject vehicle M is actuated and this position is maintained when the turn signal lever 40a is not operated. That is, when the occupant lifts the turn signal lever 40a up to the full-press position P2 once, the turn signal 70 on the left side is continuously actuated until the occupant depresses the turn signal lever 40a.

In addition, in the example, when the turn signal lever 40a is turned downward with respect to the neutral position P0 to be shifted to a half-press position P1# or a full-press position P2#, the turn signal 70 on the right side of the subject vehicle M is actuated.

The half-press position P1# is a position at which the turn signal 70 on the right side of the subject vehicle M is actuated and this position is maintained while the turn signal lever 40a is operated. The position of the turn signal lever 40a shifts to the neutral position P0 at a timing at which the turn signal lever 40a is not operated. For example, the turn signal 70 on the right side is actuated when the occupant presses the turn signal lever 40a with a hand to the half-press position P1# and, when the occupant releases the hand in this state, the turn signal lever 40a shifts to the neutral position P0 by itself and thus the actuated turn signal 70 on the right side is stopped. A state in which the turn signal lever 40a is positioned at the half-press position P1 or P1# is an example of a “second state.” In addition, a state in which the turn signal lever 40a is positioned at the half-press position P1 is an example of a “third state” and a state in which the turn signal lever 40a is positioned at the half-press position P1# is an example of a “fourth state.”

The full-press position P2# is a position at which the turn signal 70 on the right side of the subject vehicle M is actuated and this position is maintained when the turn signal lever 40a is not operated. That is, when an occupant depresses the turn signal lever 40a to the full-press position P2# once, the turn signal 70 of the right side is continuously actuated until the occupant lifts the turn signal lever 40a.

The lever position detector 40b detects which one of the neutral position P0, the half-press position P1, the full-press position P2, the half-press position P1# and the full-press position P2# is the position at which the turn signal lever 40a is positioned, for example.

Further, after the turn signal lever 40a has shifted to the full-press position P2 or P2#, the turn signal lever 40a may return to the neutral position P0 by itself when the steering wheel returns to a neutral position by using rotation of the shaft (rotation axis) of the steering wheel. That is, the turn signal lever 40a may have an auto-canceller function.

### Configuration of Master Controller

The master controller 100 includes a switching controller 110 and an HMI controller 120, for example. Each part or all of these constituent elements are realized by a processor such as a central processing unit (CPU) or a graphics processing unit (GPU) executing a program (software). Further, part or all of these constituent elements may be realized by hardware (circuit unit including circuitry) such as a large-scale integration (LSI), an application-specific integrated circuit (ASIC) and a field-programmable gate array (FPGA) or may be realized by a combination of software and hardware.

The switching controller 110 switches the driving mode of the subject vehicle M between the manual driving mode and the driving assistance mode on the basis of detection signals output according to operation of the mode switch 20a and the lane change start switch 20b of the HMI 20.

When the driving mode of the subject vehicle M is the manual driving mode, a detection signal (detection signal indicating a degree of an operation quantity of each operator) of the driving operator 40 is input to the traveling driving power output device 300, the brake device 310 and the steering device 320. Here, an input signal from the driving operator 40 may be indirectly output to the traveling driving power output device 300, the brake device 310 and the steering device 320 via the driving assistance controller 200.

In addition, when the driving mode of the subject vehicle M is the driving assistance mode, a control signal (signal indicating a control quantity of each device) from the driving assistance controller 200 is input to the traveling driving power output device 300, the brake device 310 and the steering device 320.

When the driving mode of the subject vehicle M has been switched by the switching controller 110, for example, the HMI controller 120 causes each display device, the speaker or the like of the HMI 20 to output information about the mode switching.

Prior to description of the driving assistance controller 200, the traveling driving power output device 300, the brake device 310 and the steering device 320 will be described. The traveling driving power output device 300 outputs traveling driving power (torque) for traveling of the subject vehicle M to driving wheels. For example, the traveling driving power output device 300 includes a combination of an internal combustion engine, a motor, a transmission and the like and a power electronic control unit (ECU) for controlling the combination. The power ECU controls the aforementioned components according to information input from the driving assistance controller 200 or information input from the driving operator 40.

The brake device 310 includes a brake caliper, a cylinder which transfers hydraulic pressure to the brake caliper, an electric motor which generates hydraulic pressure in the cylinder, and a brake ECU, for example. The brake ECU controls the electric motor according to information input from the driving assistance controller 200 or information input from the driving operator 40 such that a brake torque according to a braking operation is output to each wheel. The brake device 310 may include a mechanism for transferring hydraulic pressure generated according to operation of the brake pedal included in the driving operator 40 to the cylinder through a master cylinder as a backup. Further, the brake device 310 is not limited to the aforementioned configuration and may be an electronically controlled hydraulic brake device which controls an actuator according to information input from the driving assistance controller 200 to transfer hydraulic pressure of a master cylinder to a cylinder.

The steering device 320 includes a steering ECU and an electric motor, for example. The electric motor applies a force acting on a rack and piston mechanism to change a steering direction of the wheels, for example. The steering ECU drives the electric motor according to information input from the driving assistance controller 200 or information input from the driving operator 40 to change the steering direction of the wheels.

### Configuration of Driving Assistance Controller

For example, the driving assistance controller 200 includes an outside recognizer 202, a subject vehicle position recognizer 204, a following travel assistance controller 206, a lane keeping assistance controller 208, and a lane change assistance controller 210. The outside recognizer 202 or the subject vehicle position recognizer 204 is an example of a “recognizer.” In addition, the lane change assistance controller 210 is an example of a “lane change controller.”

Some or all of constituent elements of the driving assistance controller 200 may be realized by a processor such as a CPU or a GPU executing a program (software). Further, some or all of constituent elements of the driving assistance controller 200 may be realized by hardware such as an LSI, ASIC or FPGA or may be realized by a combination of software and hardware.

The outside recognizer 202 recognizes positions of neighboring vehicles and states thereof such as speed, acceleration and the like on the basis of information input from the camera 10, the radar 12 and the finder 14 through the object recognition device 16. The position of a neighboring vehicle may be represented by a representative point such as the center or a corner of the neighboring vehicle or represented by a region expressed by the contour of the neighboring vehicle. “States” of a neighboring vehicle may include the acceleration and jerk of the neighboring vehicle or an “action state” (e.g., whether the neighboring vehicle is changing lanes or intends to change lanes). In addition, the outside recognizer 202 may recognize states of other types of object such as a guard rail, an electricity pole, a parked vehicle and a pedestrian in addition to neighboring vehicles.

The subject vehicle position recognizer 204 recognizes a lane (traveling lane) in which the subject vehicle M is traveling, and a relative position and attitude of the subject vehicle M with respect to the traveling lane, for example. The subject vehicle position recognizer 204 recognizes dividing lines LM of roads from an image captured by the camera 10 and recognizes a lane marked by two dividing lines LM closest to the subject vehicle M among the recognized dividing lines LM as a traveling lane, for example. Then, the subject vehicle position recognizer 204 recognizes the position and attitude of the subject vehicle M with respect to the recognized traveling lane.

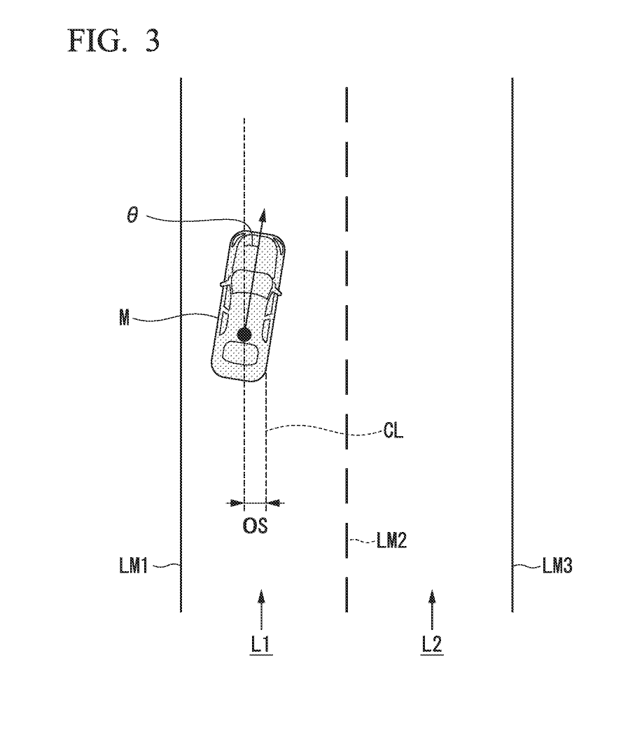

FIG. 3 is a diagram showing a state in which a relative position and attitude of the subject vehicle M with respect to a traveling lane L1 are recognized by the subject vehicle position recognizer 204. For example, the subject vehicle position recognizer 204 recognizes dividing lines LM1 to LM3 and recognizes an area between the dividing lines LM1 and LM2 closest to the subject vehicle M as a traveling lane L1 of the subject vehicle. In addition, the subject vehicle position recognizer 204 recognizes both a deviation OS from a traveling lane center CL of a reference point (for example, the center of gravity) of the subject vehicle M and an angle θ formed by the travel direction of the subject vehicle M relative to an extension line of the traveling lane center CL as the relative position and orientation of the subject vehicle M with respect to the traveling lane L1. Alternatively, the subject vehicle position recognizer 204 may recognize the position of the reference point on the subject vehicle M and the like with respect to any of the sides of an own lane L1 as a relative position of the subject vehicle M with respect to the traveling lane.

In addition, the subject vehicle position recognizer 204 may recognize a neighboring lane adjacent to an own lane, for example. For example, the subject vehicle position recognizer 204 may recognize an area between a dividing line closest to the subject vehicle M and a dividing line of a traveling lane next to the dividing line of the own lane as a neighboring lane. In the example of FIG. 3, the subject vehicle position recognizer 204 may recognize an area between the dividing line LM2 of the own lane and a dividing line LM3 next to the dividing line LM2 as a right neighboring lane L2, for example.

For example, the following travel assistance controller 206 controls the traveling driving power output device 300 and the brake device 310 such that the subject vehicle M accelerates or decelerates within a range of predetermined set vehicle speeds (e.g., 50 to 100 [km/h]) such that the subject vehicle M follows a neighboring vehicle (hereinafter referred to as a preceding vehicle) existing within a predetermined distance (e.g., approximately 50 [m]) in front of the subject vehicle M among neighboring vehicles recognized by the outside recognizer 202. For example, “following” is a traveling state in which a constant relative distance between the subject vehicle M and a preceding vehicle (a distance between vehicles) is maintained. In the following description, driving assistance control for assisting traveling of the subject vehicle M in such a traveling state is referred to as “following travel assistance control. The following travel assistance controller 206 may simply cause the subject vehicle M to travel within the range of the set vehicle speeds when no preceding vehicle is recognized by the outside recognizer 202.

The lane keeping assistance controller 208 controls the steering device 320 such that the own lane recognized by the subject vehicle position recognizer 204 is kept. For example, the lane keeping assistance controller 208 controls steering of the subject vehicle M such that the subject vehicle M travels at the center of the own lane. In the following description, driving assistance control for controlling the subject vehicle to travel at the center of the own lane is referred to as “lane keeping assistance control.”

In addition, when the subject vehicle M is traveling at a position deviating from the center of the own lane to the left or right, the lane keeping assistance controller 208 performs road deviation inhibition control. For example, the lane keeping assistance controller 208 performs control described below as road deviation inhibition control.

For example, when the subject vehicle M approaches the dividing line LM of the own lane such that a distance between the dividing line LM of the own lane and the subject vehicle M becomes equal to or shorter than a predetermined distance, the lane keeping assistance controller 208 draws the attention of the occupant by vibrating the steering wheel. Here, the HMI controller 120 notifies the occupant that the subject vehicle M is likely to be about to deviate from the own lane by displaying an image on each display device of the HMI 20 or outputting a voice or the like from the speaker. When there is no occupant operation of the steering wheel after the steering wheel is vibrated (when a steering angle or a steering torque is less than a threshold value), the lane keeping assistance controller 208 changes the steering direction of the wheels to the center of the lane by controlling the steering device 320 and controls steering such that the subject vehicle M returns to the center of the lane.

The lane change assistance controller 210 includes a lane change permissibility determiner 211 and a lane change executor 212, for example.

When the turn signal lever 40a is positioned at the half-press position P1 or P1# for a first predetermined time Ta or longer, for example, the lane change permissibility determiner 211 determines whether lane change to a neighboring lane on the side of a turn signal which is actuated according to the position at which the turn signal lever 40a is positioned (e.g., the right neighboring lane if the right turn signal 70 is actuated) among the right and left neighboring lanes of the subject vehicle M is allowable. For example, the lane change permissibility determiner 211 determines that lane change is allowable when all conditions below are satisfied and determines that lane change is not allowable when any of the conditions is not satisfied. Further, the lane change permissibility determiner 211 may start determination when the lane change start switch 20b or the turn signal lever substitute switch 20c is operated instead of or in addition to starting determination when the turn signal lever 40a is positioned at the half-press position P1 or P1# for the first predetermined time Ta or longer.

Condition (1): There are no obstacles in a lane which is a lane change destination.

Condition (2): A dividing line LM dividing a lane which is a lane change destination and the own lane is not a road marking indicating prohibition of lane change (prohibition of lane crossing).

Condition (3): A lane which is a lane change destination has been recognized (exists).

Condition (4): A yaw rate detected by the vehicle sensor 30 is less than a threshold value.

Condition (5): The radius of curvature of a road on which the subject vehicle is traveling is equal to or greater than a predetermined value.

Condition (6): The speed of the subject vehicle M is within a predetermined speed range.

Condition (7): Another driving assistance control having higher priority than steering assistance control for lane change is not being performed.

Condition (8): A predetermined time or longer has elapsed after switching from the manual driving mode to the driving assistance mode.

### Method of Determining Condition (1)

For example, to determine whether condition (1) is satisfied, the lane change permissibility determiner 211 sets a target position (hereinafter referred to as a lane change target position TAs) which is a lane change destination in a neighboring lane and determines whether a neighboring vehicle exists as an obstacle at the lane change target position TAs.

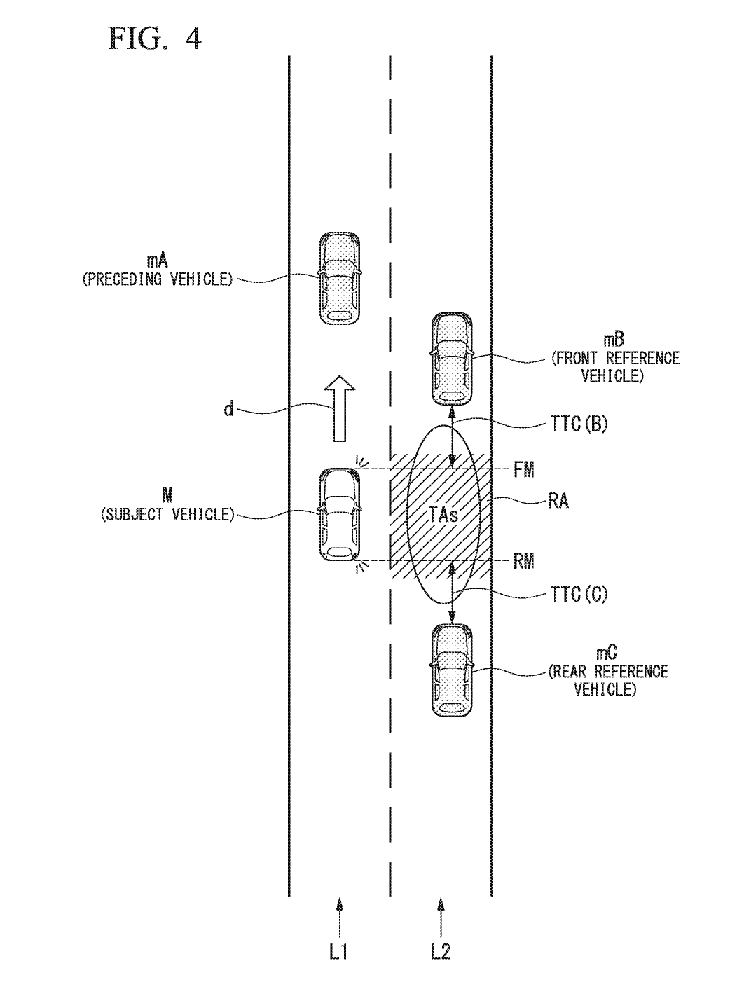

FIG. 4 is a diagram schematically showing a state in which the lane change target position TAs is set in a neighboring lane. In the figure, L1 represents an own lane and L2 is the right neighboring lane. In addition, an arrow d represents an advancing (traveling) direction of the subject vehicle M. For example, when lane change to the right neighboring lane L2 is indicated according to operation of the turn signal lever 40a, the lane change permissibility determiner 211 selects any two vehicles (e.g., two vehicles relatively close to the subject vehicle M) from neighboring vehicles existing in the right neighboring lane L2 and sets the lane change target position TAs between the selected two neighboring vehicles. For example, the lane change target position TAs is set to the center of the neighboring lane. In the following description, a neighboring vehicle existing immediately before the set lane change target position TAs is referred to as a “front reference vehicle mB” and a neighboring vehicle existing immediately after the lane change target position TAs is referred to as a “rear reference vehicle mC.” The lane change target position TAs is a relative position based on a positional relationship between the subject vehicle M and the front reference vehicle mB and the rear reference vehicle mC.

After the lane change target position TAs is set, the lane change permissibility determiner 211 sets a prohibition area RA as shown in the figure on the basis of the position at which the lane change target position TAs is set. For example, the lane change permissibility determiner 211 projects the subject vehicle M to the neighboring lane L2 which is the lane change destination and sets an area having a slight allowance distance before and after the projected the subject vehicle M as the prohibition area RA. The prohibition area RA is set as an area extending from one dividing line LM to the other dividing line LM dividing the neighboring lane L2.

In addition, the lane change permissibility determiner 211 determines that condition (1) is satisfied when no parts of a neighboring vehicle exist in the set prohibition area RA, a time-to-collision TTC(B) between the subject vehicle M and the front reference vehicle mB is greater than a threshold value Th(B), and a time-to-collision TTC(C) between the subject vehicle M and the rear reference vehicle mC is greater than a threshold value Th(C). For example, “no parts of a neighboring vehicle exist in the prohibition area RA” means that the prohibition area A and the area indicating the neighboring vehicle do not overlap with each other when viewed from the above. In addition, the time-to-collision TTC(B) is derived by dividing a distance between an extension line FM virtually extending from the front end of the subject vehicle M to the neighboring lane L2 and the front reference vehicle mB by a relative speed of the subject vehicle M and the front reference vehicle mB, for example. Further, the time-to-collision TTC(C) is derived by dividing a distance between an extension line RM virtually extending from the rear end of the subject vehicle M to the neighboring lane L2 and the rear reference vehicle mC by a relative speed of the subject vehicle M and the rear reference vehicle mC, for example. The threshold value Th(B) and the threshold value Th(C) may be the same value or different values.

When condition (1) is not satisfied, the lane change permissibility determiner 211 repeats the process of determining whether condition (1) is satisfied by selecting two other vehicles from neighboring vehicles existing in the right neighboring lane L2 and newly setting a lane change target position TAs. Here, the driving assistance controller 200 may control the speed of the subject vehicle M such that the current speed is maintained or accelerate/decelerate the subject vehicle M such that the subject vehicle M moves to the side of the lane change target position TAs until a lane change target position TAs which satisfies condition (1) is set.

If no neighboring vehicle exists in the neighboring lane L2 when the lane change target position TAs is set, the lane change permissibility determiner 211 may determine that condition (1) is satisfied from absence of a neighboring vehicle interfering with the prohibition area RA. Further, if only one neighboring vehicle exists in the neighboring lane L2 when the lane change target position TAs is set, the lane change permissibility determiner 211 may set the lane change target position TAs at any position before and after the neighboring vehicle.

### Method of Determining Condition (2)

For example, the lane change permissibility determiner 211 determines whether condition (2) is satisfied according to the type of a dividing line between the own lane recognized by the subject vehicle position recognizer 204 and a neighboring lane which is a lane change destination, that is, a dividing line which needs to be crossed during lane change. For example, it is determined that condition (2) is not satisfied when the dividing line between the own lane and the neighboring lane which is the lane change destination is a road marking (e.g., a yellow solid line) indicating prohibition of lane change or prohibition of lane crossing, whereas it is determined that condition (2) is satisfied when the dividing line is a road marking (e.g., a white dashed line) which does not indicate prohibition of lane change or prohibition of lane crossing.

### Method of Determining Condition (3)

For example, when the turn signal lever 40a, the lane change start switch 20b or the turn signal lever substitute switch 20c is operated to indicate lane change, the lane change permissibility determiner 211 determines that condition (3) is not satisfied if a lane indicated as a lane change destination is not recognized by the subject vehicle position recognizer 204 and determines that condition (3) is satisfied if the lane is recognized by the subject vehicle position recognizer 204. Accordingly, when lane change to a side at which a neighboring lane does not exist is indicated according to an erroneous operation of the occupant, for example, lane change is not started because the subject vehicle position recognizer 204 does not recognize the lane indicated as a lane change destination.

### Method of Determining Condition (4)

For example, the lane change permissibility determiner 211 determines whether condition (4) is satisfied according to whether a yaw rate detected by the vehicle sensor 30 is less than a threshold value. The threshold value is set to a yaw rate of a degree by which an overload (a state in which acceleration in the vehicle width direction becomes equal to or greater than a threshold value) does not occur for the occupant when lanes are changed, for example. The lane change permissibility determiner 211 determines that condition (4) is not satisfied when the yaw rate is equal to or greater than the threshold value and determines that condition (4) is satisfied when the yaw rate is less than the threshold value.

### Method of Determining Condition (5)

For example, the lane change permissibility determiner 211 determines whether condition (5) is satisfied according to whether the radius of curvature of a road on which the subject vehicle M is traveling is equal to or greater than a predetermined value. For example, the predetermined value is set to a radius of curvature (e.g., about 500 [m]) at which an overload does not occur for the occupant when the subject vehicle M travels along the road. Further, the predetermined value may be set to a smaller value (e.g., about 200 [m]) when the speed of the subject vehicle M decreases and set to a larger value (e.g., about 1,000 [m]) when the speed of the subject vehicle M increases.

### Method of Determining Condition (6)

For example, the lane change permissibility determiner 211 determines whether condition (6) is satisfied according to whether the speed of the subject vehicle M is within a predetermined speed range. The predetermined speed range is set to a speed range of about 70 to 110 [km/h], for example. The lane change permissibility determiner 211 determines that condition (6) is not satisfied when the speed of the subject vehicle M is not within the predetermined speed range and determines that condition (6) is satisfied when the speed of the subject vehicle M is within the predetermined speed range.

### Method of Determining Condition (7)

For example, the lane change permissibility determiner 211 determines whether condition (7) is satisfied according to whether another driving assistance control having higher priority than steering assistance control for lane change is being performed. For example, driving assistance control having highest priority is braking control (hereinafter referred to as automatic braking control) for automatically decelerating the subject vehicle M in response to an obstacle. For example, the lane change permissibility determiner 211 determines that condition (7) is not satisfied if automatic braking control is performed when lane change permissibility is determined and determines that condition (7) is satisfied if not.

### Method of Determining Condition (8)

For example, the lane change permissibility determiner 211 determines whether condition (8) is satisfied according to a time which has elapsed after the driving mode of the subject vehicle M has switched from the manual driving mode to the driving assistance mode by the switching controller 110. For example, the lane change permissibility determiner 211 determines that condition (8) is not satisfied when a predetermined time or longer has not elapsed after the driving mode has switched to the driving assistance mode and determines that condition (8) is satisfied when the predetermined time or longer has elapsed. For example, the predetermined time is set to about 2 seconds. Accordingly, it is possible to start lane change after transition of the state of the subject vehicle M to a normal state in the driving assistance mode.

The lane change permissibility determiner 211 may sequentially determine whether lane change is allowable irrespective of whether the turn signal lever 40a, the lane change start switch 20b or the turn signal lever substitute switch 20c is operated. Here, when both the left and right neighboring lanes are recognized, that is, there are two lanes which may be changed to, the lane change permissibility determiner 211 determines whether the aforementioned condition is satisfied for each lane.

When the lane change permissibility determiner 211 determines that lane change is allowable, the lane change executor 212 controls the traveling driving power output device 300, the brake device 310 and the steering device 320 independently of a steering wheel operation of the occupant (steering wheel operation) to change lanes of the subject vehicle M to a neighboring lane (neighboring lane in which the lane change target position TAs is set) determined to be able to be changed to. Here, the lane change executor 212 actuates the turn signal 70.

For example, the lane change executor 212 may determine a target speed before the subject vehicle M will arrive at the lane change target position TAs on the basis of relative speeds with respect to neighboring vehicles (the front reference vehicle mB and the rear reference vehicle mC) before and after the lane change target position TAs set by the lane change permissibility determiner 211 and a relative distance to the lane change target position TAs, and control the traveling driving power output device 300 and the brake device 310 such that the speed of the subject vehicle M becomes close to the determined target speed. In addition, the lane change executor 212 may determine a target steering angle before the subject vehicle M arrives at the lane change target position TAs on the basis of a relative distance with respect to the vehicle advancing direction to the lane change target position TAs and a relative distance with respect to the vehicle width direction and control the steering device 320 such that the steering angle of the subject vehicle M becomes close to the determined target steering angle. In the following description, driving assistance control for changing lanes of the subject vehicle M from the subject vehicle to a neighboring lane is referred to as “automatic lane change assistance control.” Automatic lane change assistance control is an example of “lane change control.”

### Situation in which Automatic Lane Change Assistance Control is Performed

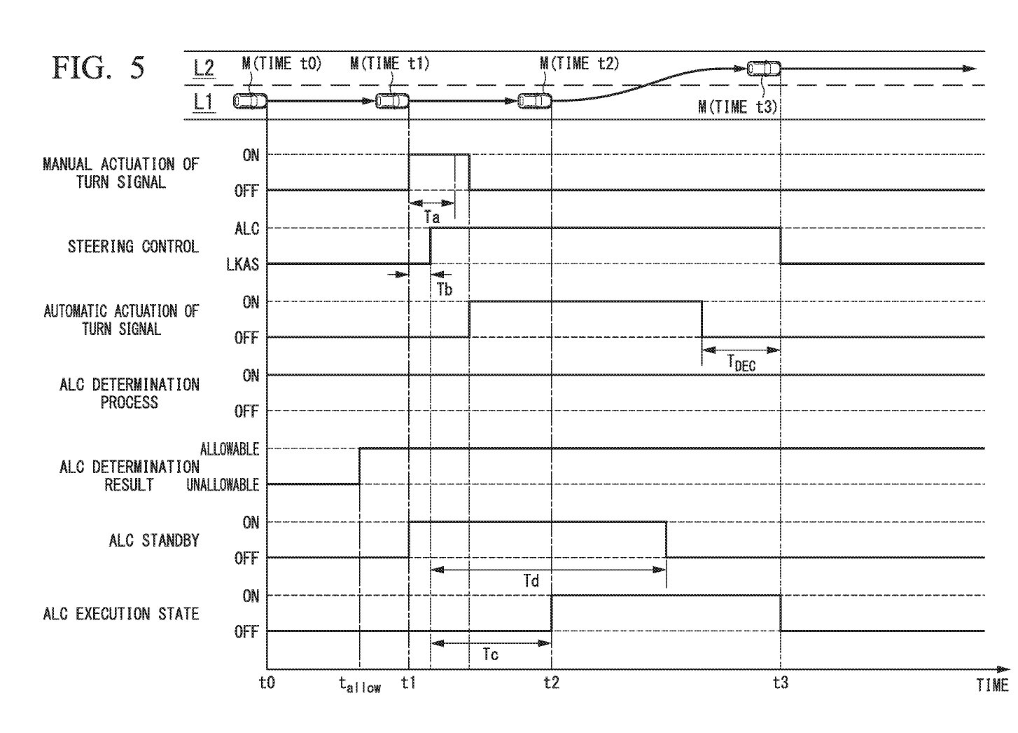

FIG. 5 is a diagram showing a situation in which automatic lane change assistance control is performed together with a timing chart showing a timing of each control. In the figure, ALC (Auto Lane Change) represents automatic lane change assistance control and LKAS (Lane Keeping Assist System) represents lane keeping assistance control. In addition, it is assumed that the lane change permissibility determiner 211 has already started the lane change permissibility determination process before the turn signal lever 40a or the turn signal lever substitute switch 20c is operated in the description below. In the example, a state in which the lane change permissibility determination process is performed is represented as “ON state” and a state in which this determination process is not performed is represented as “OFF state.” In addition, the illustrated example represents that lane change is determined to be allowable at a point in time of time t_{allow} (ALC determination result “allow” in the figure).

The illustrated example represents that the turn signal 70 is not actuated and the control state when the steering device 320 is controlled is lane keeping assistance control LKAS at a point in time of time t0.

A time t1 represents a timing at which the occupant shifts the turn signal lever 40a to the half-press position P1 in order to indicate lane change to the left neighboring lane L2. In this case, the left turn signal 70 of the subject vehicle M is actuated (manual turn signal actuation state switches from an OFF state to an ON state). Further, the time t1 may represent a timing at which the turn signal lever substitute switch 20c is operated.

For example, when the turn signal lever 40a is shifted to the half-press position P1, the lane change permissibility determiner 211 counts the time for which that position is maintained. That is, the lane change permissibility determiner 211 counts the time from when the occupant uplifts the turn signal lever 40a to the half-press position P1 with a hand to when the occupant releases the hand. The lane change permissibility determiner 211 determines whether the counted time is equal to or longer than a first predetermined time Ta, permits continuous actuation of the turn signal 70 if lane change is allowable and the counted time is equal to or longer than the first predetermined time Ta, and prohibits actuation of the turn signal 70 if lane change is not allowable or the counted time is not equal to or longer than the first predetermined time Ta.

When lane change is allowable and the counted time is equal to or longer than the first predetermined time Ta, that is, when continuous actuation of the turn signal 70 is permitted, the lane change executor 212 actuates the turn signal 70 independently of operation of the turn signal lever 40a when the turn signal lever 40a returns to the neutral position P0 from the half-press position P1. That is, the lane change executor 212 automatically actuates the turn signal 70 (automatic turn signal actuation state switches from an OFF state to an ON state).

In the illustrated example, the lane change permissibility determiner 211 determines that lane change is allowable at a time t_{allow} before the time t1. Accordingly, the lane change executor 212 automatically actuates the turn signal 70 after a timing which has elapsed from the time t1 by the first predetermined time Ta. When the turn signal 70 is a one-touch turn signal which automatically blinks for a predetermined time (e.g., 3 seconds) or a predetermined number of times (e.g., 3 or 4 times), it may be possible to continuously actuate the turn signal 70 such that automatic blinking of the one-touch turn signal appears to continue such that the turn signal 70 is not turned off even when the occupant releases the hand from the turn signal lever 40a after the first predetermined time Ta has elapsed by setting the first predetermined time Ta to a shorter time than a time for which the one-touch turn signal automatically blinks even if the turn signal lever 40a has returned to the neutral position P0 from the half-press position P1 (or half-press position P1#). Further, in the example of FIG. 5, automatic turn signal actuation switches from an OFF state to an ON state at a timing at which manual turn signal actuation switches from an ON state to an OFF state for convenience. A state in which the turn signal 70 automatically blinks for a predetermined time or a predetermined number of times even after returning to the neutral position P0 is another example of the “second state.”

Furthermore, at the time t1, the functional unit which controls the steering device 320 according to actuation of the turn signal 70 switches from the lane keeping assistance controller 208 to the lane change assistance controller 210. That is, the control right of the steering device 320 is transferred from the lane keeping assistance controller 208 to the lane change assistance controller 210. In addition, a second predetermined time Tb for continuing determination until any one of results of determining that the turn signal lever 40a or the turn signal lever substitute switch 20c has been operated and determining that it has not been operated is obtained is set. When the turn signal lever 40a or the turn signal lever substitute switch 20c has been continuously operated until the second predetermined time Tb elapses from the time t1 at which the turn signal lever 40a or the turn signal lever substitute switch 20c has started to be operated, the lane change permissibility determiner 211 determines that the occupant intends to indicate lane change and starts various types of control. On the other hand, when the turn signal lever 40a or the turn signal lever substitute switch 20c was not operated before the second predetermined time Tb elapses from the time t1 at which the turn signal lever 40a or the turn signal lever substitute switch 20c has started to be operated, the lane change permissibility determiner 211 determines that the occupant has no intention of indicating lane change and does not start various types of control. In this manner, it may be possible to restrain execution of automatic lane change assistance control on the basis of erroneous lane change indication by setting the second predetermined time Tb, for example, when the occupant erroneously touches the turn signal lever 40a when operating the steering wheel 44, the occupant unintentionally operates the turn signal lever 40a when operating a light switch or the like for turning on the headlights or the like, or chattering occurs in an operation with respect to the turn signal lever 40a. In addition, since the lane change assistance controller 210 does not have the control right of the steering device 320 until the second predetermined time Tb elapses from the time t1 at which the turn signal lever 40a or the turn signal lever substitute switch 20c has started to be operated, automatic lane change assistance control (ALC) is not started if the lane change permissibility determiner 211 provisionally determines that lane change is allowable.

In addition, the lane change permissibility determiner 211 determines whether the time counted from the time t1 is longer than a third predetermined time Tc and shorter than a fourth predetermined time Td. Here, the lane change permissibility determiner 211 may start time counting from a point in time t1+Tb which has further elapsed from the time t1 which is the actuation timing of the turn signal 70 by the second predetermined time Tb, as shown, or may start time counting from the time t1 without considering the second predetermined time Tb.

When the counted time is equal to or longer than the third predetermined time Tc and shorter than the fourth predetermined time Td, the lane change permissibility determiner 211 permits execution of automatic lane change assistance control (ALC) and prohibits execution of automatic lane change assistance control (ALC) in other cases.

The third predetermined time Tc is a time set to inform neighboring vehicles of a sign of lane change of the subject vehicle M. In other words, the third predetermined time Tc is a time which is set in order to continue turn on (blinking) of the turn signal 70 for a while, while keeping traveling along the own lane. The fourth predetermined time Td is set to a time longer than the third predetermined time Tc. For example, the third predetermined time Tc is set to several seconds approximately and the fourth predetermined time Td is set to about ten seconds.

For example, when the lane change permissibility determiner 211 determines that lane change is allowable in a period of time from the start of time counting to when the third predetermined time Tc elapses, the lane change permissibility determiner 211 also prohibits execution of automatic lane change assistance control (ALC) in this period of time. In this case, the lane change executor 212 waits for execution of automatic lane change assistance control (ALC) until the third predetermined time Tc elapses since the lane change permissibility determiner 211 has already determined that lane change is allowable and starts of automatic lane change assistance control (ALC) at a time t1+Tb+Tc which has passed the third predetermined time Tc. Accordingly, lane change is not started until at least the third predetermined time Tc elapses, and thus neighboring vehicles may be sufficiently informed of intention of lane change. Further, when the control state when the steering device 320 is controlled has changed from lane keeping assistance control (LKAS) to automatic lane change assistance control (ALC), lane keeping assistance control (LKAS) also continues until the third predetermined time Tc elapses and the lane change permissibility determiner 211 determines that lane change is allowable. That is, automatic lane change assistance control (ALC) is to continue control for keeping the own lane until lane change is actually allowable.

Furthermore, in a case in which the third predetermined time Tc has elapsed from the start of time counting and the fourth predetermined time Td has not elapsed, when the lane change permissibility determiner 211 determines that lane change is allowable, the lane change executor 212 starts automatic lane change assistance control (ALC) at the time when lane change is determined to be allowable.

In the illustrated example, the lane change executor 212 starts automatic lane change assistance control (ALC) (ALC execution state switches from an OFF state to an ON state) at a time which has passed the third predetermined time Tc because the lane change permissibility determiner 211 has determined that lane change is allowable before the time t1.

In addition, the lane change executor 212 stops automatic lane change assistance control (ALC) at a time at which lane change to the neighboring lane L2 which is the lane change destination is completed. For example, “time at which lane change is competed” is a timing at which the subject vehicle M has arrived at the center of the neighboring lane L2. In the illustrated example, automatic lane change assistance control (ALC) is stopped at a time t3. Here, the lane change executor 212 stops the automatically actuated turn signal 70 at a time a fifth predetermined time T_{DEC} before the time T3 at which completion of lane change is predicted. For example, the fifth predetermined time T_{DEC} is set to a time necessary for the subject vehicle M to travel an offset distance D_{DEC} in the vehicle width direction which is set at the side of the own lane on the basis of the center of the neighboring lane which is the lane change destination on the assumption that the speed of the subject vehicle M is constant. For example, the offset distance D_{DEC} is set to a distance shorter than half the maximum width of the neighboring lane. That is, the offset distance D_{DEC} is set to a distance which does not reach the own lane from the center of the neighboring lane.

Further, the lane change permissibility determiner 211 may stop the lane change permissibility determination process according to stopping of automatic lane change assistance control (ALC). In addition, the control right of the steering device 320 is transferred from the lane change assistance controller 210 to the lane keeping assistance controller 208 according to stopping of automatic lane change assistance control (ALC). That is, lane keeping assistance control (LKAS) stopped during execution of automatic lane change assistance control (ALC) is resumed. Further, when conditions for permitting lane change are not established, the lane change permissibility determiner 211 may repeatedly set the lane change target position TAs and search a space of a lane change destination until the second predetermined time Tb elapses.

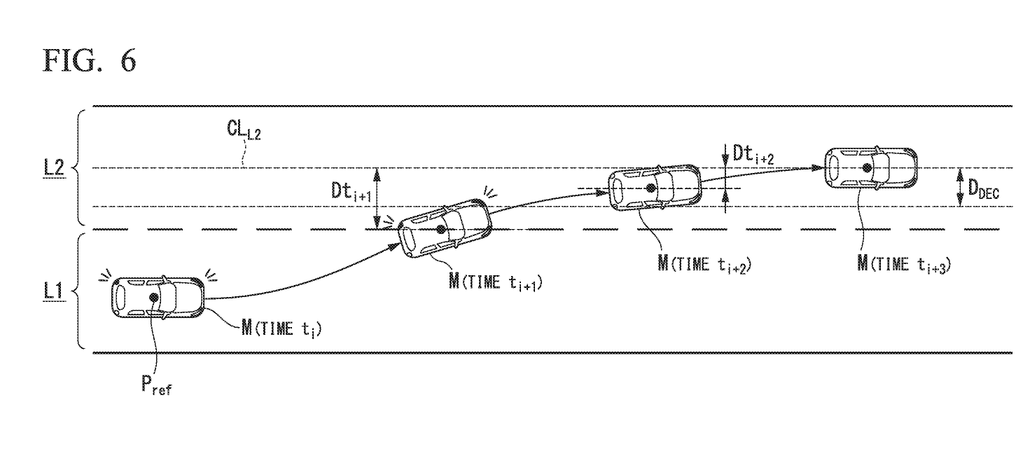

FIG. 6 is a diagram describing a target position of a neighboring lane which is a lane change destination. For example, when the lane change executor 212 starts automatic lane change assistance control (ALC) at a certain time tᵢ, the lane change executor 212 determines a timing at which the actuated turn signal 70 is stopped according to whether a distance between a reference point P_{ref} (e.g., the center) of the subject vehicle M and the center CL_{L2} of the left neighboring lane L2 which is the lane change destination is longer than the offset distance D_{DEC}.

For example, at time tᵢ₊₁, the distance between the reference point P_{ref} and the center CL_{L2} of the left neighboring lane L2 is Dtᵢ₊₁ which is longer than the offset distance D_{DEC}, and thus the lane change executor 212 continuously actuates the turn signal 70. At time tᵢ₊₂, the distance between the reference point P_{ref} and the center CL_{L2} of the left neighboring lane L2 is Dtᵢ₊₂ which is shorter than the offset distance D_{DEC}, and thus the lane change executor 212 stops the actuated turn signal 70. Accordingly, it may be possible to inform neighboring vehicles of a sign of lane change of the subject vehicle M and to match a timing at which the occupant feels completion of lane change of the subject vehicle M with a timing at which the vehicle control system 1 determines completion of lane change.

In general, when the turn signal 70 is actuated while lane change is performed, it is necessary to shift the turn signal lever 40a to the full-press position. In this case, even if lane change is completed, when the steering angle of the steering wheel slightly changes, the turn signal lever 40a may not return to the neutral position P0 even though it has the auto-canceller function and thus the occupant needs to operate the turn signal lever 40a to return the turn signal lever 40a to the neutral position P0. In such a case, stopping the actuation of the turn signal 70 is a burden on the occupant.

Whereas, in the present embodiment, the turn signal 70 is continuously actuated independently of an operation of the occupant until the subject vehicle M arrives at the offset distance D_{DEC} set on the basis of the center of the neighboring lane or the current time reaches a time the fifth predetermined time T_{DEC} before the time at which completion of lane change is predicted and the actuated turn signal 70 is stopped when the subject vehicle M has arrived at the offset distance D_{DEC} or the current time has reached the time. Accordingly, the occupant need not stop the turn signal 70 when actuation of the turn signal 70 is not stopped irrespective of completion of lane change. As a result, it may be possible to avoid the burden on the occupant of stopping the turn signal 70.

### Situation in which Automatic Lane Change Assistance Control is not Performed

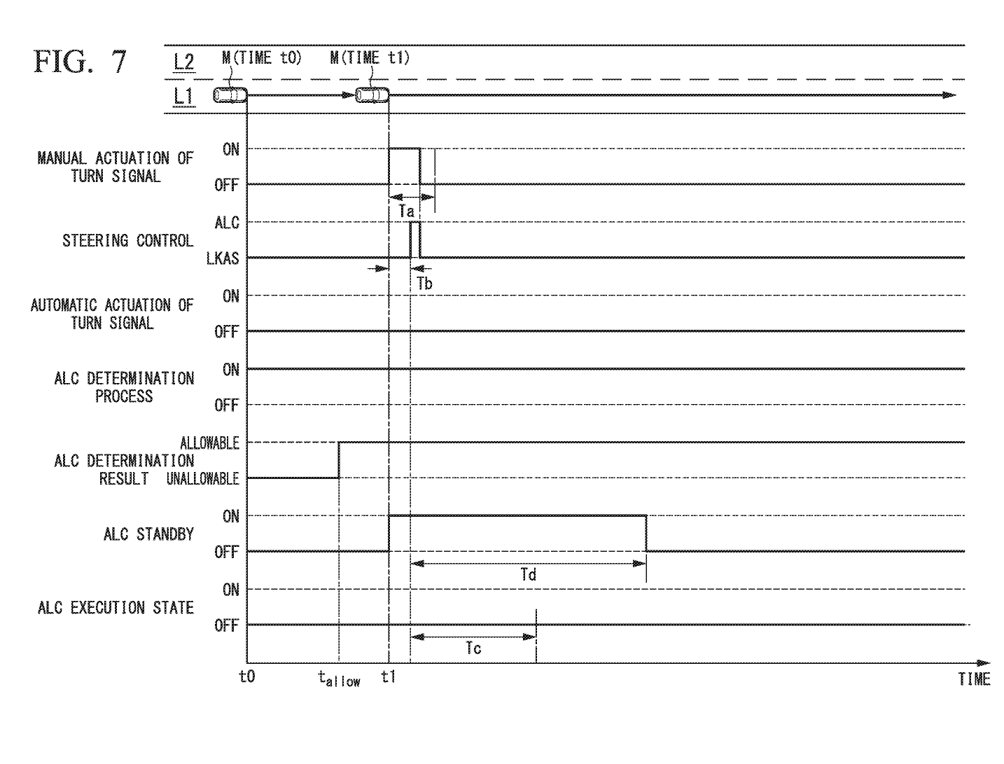

FIG. 7 is a diagram showing a situation in which automatic lane change assistance control is not performed together with a timing chart showing a timing of each control. In the example of FIG. 7, the lane change permissibility determiner 211 determines that lane change is allowable at the time t_{allow} before the turn signal lever 40a or the turn signal lever substitute switch 20c is operated as in the above-described example.

In the illustrated example, since a time which has elapsed from when the turn signal lever 40a has been positioned at the half-press position P1 is less than the first predetermined time Ta, the lane change permissibility determiner 211 determines that the operation of the turn signal lever 40a at the time t1 is not an operation indicating lane change and prohibits actuation of the turn signal 70. Accordingly, the lane change executor 212 does not actuate the turn signal 70 and cancels automatic lane change assistance control (ALC) without executing it, and instead the lane keeping assistance controller 208 continues lane keeping assistance control (LKAS) (automatic turn signal actuation state is maintained in the OFF state).

### Another Situation in which Automatic Lane Change Assistance Control is not Performed

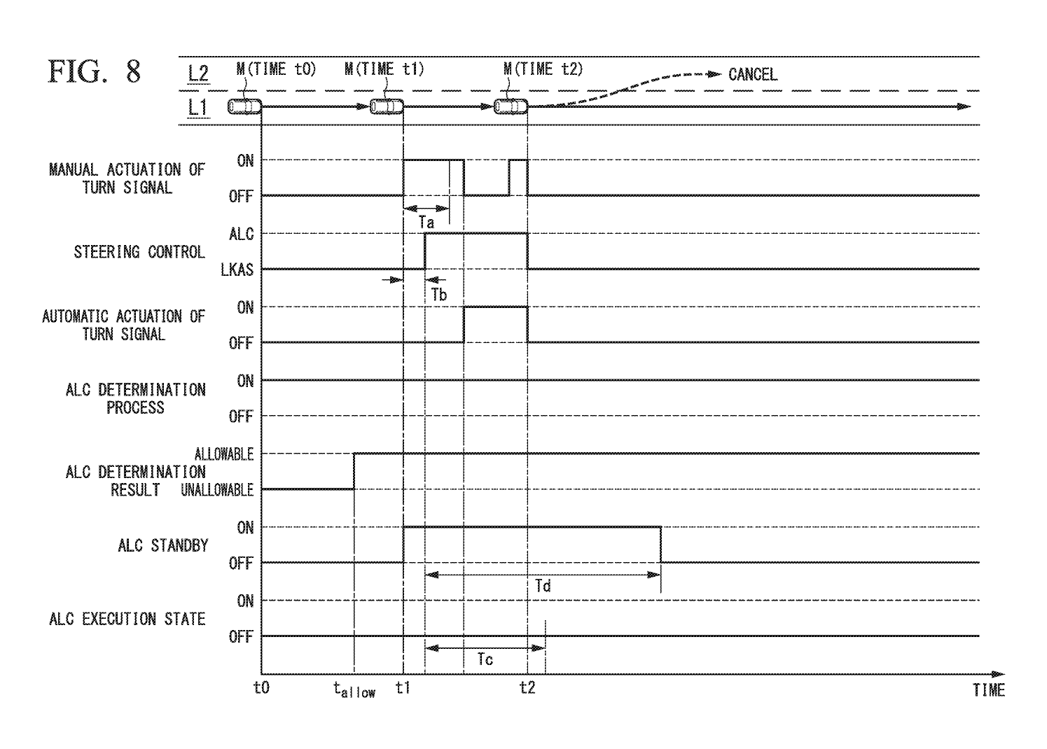

FIG. 8 is a diagram showing a situation in which automatic lane change assistance control is not performed together with a timing chart showing a timing of each control. In the example of FIG. 8, the lane change permissibility determiner 211 determines that lane change is allowable at the time t_{allow} before the turn signal lever 40a or the turn signal lever substitute switch 20c is operated as in the above-described example.

In the illustrated example, the time elapsed from when the turn signal lever 40a has shifted to the half-press position P1 is equal to or longer than the first predetermined time Ta, and thus the lane change permissibility determiner 211 determines that the operation of the turn signal lever 40a at the time t1 is an operation indicating lane change and permits the turn signal 70 to be continuously actuated. Accordingly, the lane change executor 212 actuates the turn signal 70 (automatic turn signal actuation state switches from an OFF state to an ON state) independently of the operation of the turn signal lever 40a when the turn signal lever 40a returns to the neutral positon P0 from the half-press position P1.

In addition, in the illustrated example, the turn signal lever 40a which has returned to the neutral position P0 from the half-press position P1 is operated again before the counted time exceeds the third predetermined time Tc. That is, before the lane change executor 212 executes automatic lane change assistance control (ALC) by receiving the first operation of the turn signal lever 40a, the turn signal lever 40a is operated again. In this case, the lane change permissibility determiner 211 determines that the second operation performed on the turn signal lever 40a is an operation for canceling the first operation performed on the turn signal lever 40a and prohibits actuation of the turn signal 70.

For example, when the turn signal lever 40a has shifted to the half-press position P1 for actuating the left turn signal 70 first and then shifted to the half-press position P1# for actuating the right turn signal 70 as a second operation, the lane change permissibility determiner 211 determines that the second operation is an operation for canceling the first operation. That is, when a direction opposite to a direction indicated as a lane change destination first time is indicated as a direction of a lane change destination through a second operation, the lane change permissibility determiner 211 determines that the second operation is an operation for canceling the operation performed first time.

The above-described example is exemplary and, when the turn signal lever 40a has shifted to the half-press position P1 first time and then also shifted to the half-press position P1 second time, that is, the same direction as the direction indicated as a lane change destination first time is indicated as a direction of a lane change destination through the second operation, for example, the lane change permissibility determiner 211 may determine that this is an operation for canceling the operation performed first time.

Accordingly, the lane change executor 212 stops the turn signal 70 that has already been actuated and cancels automatic lane change assistance control (ALC) without executing it. Instead the lane keeping assistance controller 208 continues lane keeping assistance control (LKAS) (automatic turn signal actuation state is maintained in the OFF state).

### Another Situation in which Automatic Lane Change Assistance Control is not Performed

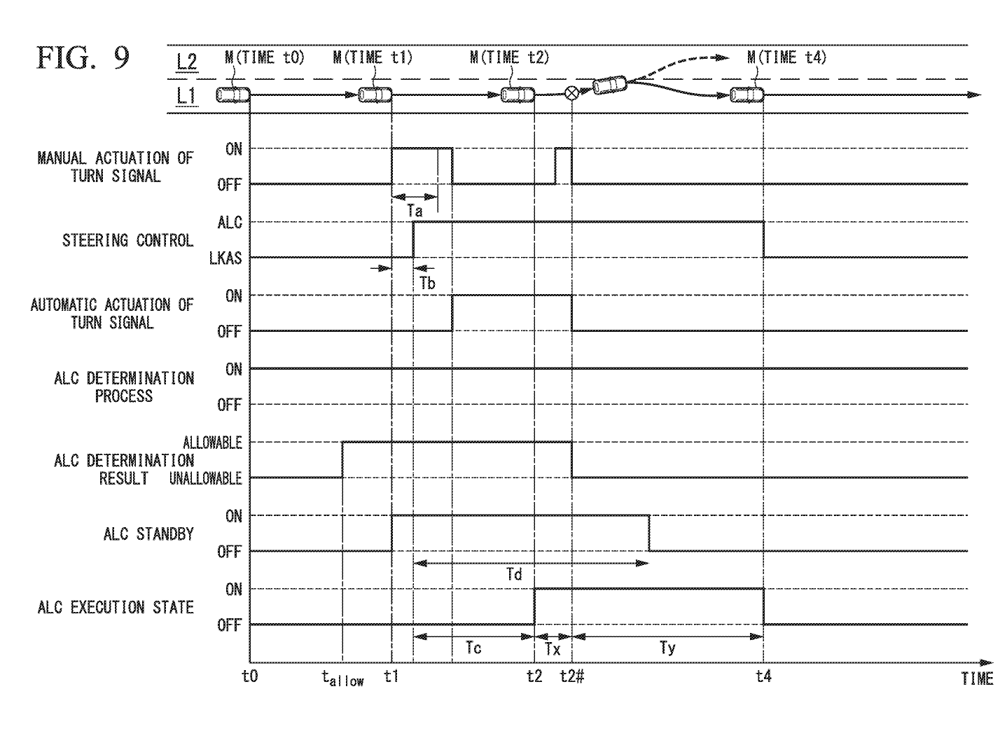

FIG. 9 is a diagram showing a situation in which automatic lane change assistance control is not performed together with a timing chart showing a timing of each control. In the example of FIG. 9, the lane change permissibility determiner 211 determines that lane change is allowable at the time t_{allow} before the turn signal lever 40a or the turn signal lever substitute switch 20c is operated as in the above-described example.

In the illustrated example, the time elapsed from when the turn signal lever 40a has shifted to the half-press position P1 is equal to or longer than the first predetermined time Ta, and thus the lane change permissibility determiner 211 determines that the operation of the turn signal lever 40a at the time t1 is an operation indicating lane change and permits the turn signal 70 to be continuously actuated. Accordingly, the lane change executor 212 actuates the turn signal 70 (automatic turn signal actuation state switches from an OFF state to an ON state) independently of the operation of the turn signal lever 40a when the turn signal lever 40a returns to the neutral position P0 from the half-press position P1.

In addition, in the illustrated example, the turn signal lever 40a which has returned to the neutral position P0 from the half-press position P1 shifts to the half-press position P1 again at the time t2# at which the counted time is equal to or longer than the third predetermined time Tc and does not reach the fourth predetermined time Td. That is, after the lane change executor 212 executes automatic lane change assistance control (ALC) by receiving the first operation of the turn signal lever 40a, the turn signal lever 40a is operated again. In this case, the lane change permissibility determiner 211 determines that the previous turn signal lever operation was not an operation indicating lane change and determines whether automatic lane change assistance control (ALC) which has already been executed can be stopped.

For example, the lane change permissibility determiner 211 determines whether the subject vehicle M crosses a dividing line dividing the own lane L1 and a left neighboring lane L2 when the subject vehicle M has traveled for a predetermined time or by a predetermined distance while keeping the current vehicle speed. More specifically, the lane change permissibility determiner 211 determines that the subject vehicle M will cross the dividing line when it is predicted that the reference point Pref of the subject vehicle M will cross the dividing line from a result of traveling of the subject vehicle M for a predetermined time or by a predetermined distance while keeping the current vehicle speed and determines that the subject vehicle M will not cross the dividing line when it is predicted that the reference point Pref of the subject vehicle M will not cross the dividing line.

The lane change permissibility determiner 211 determines that automatic lane change assistance control (ALC) which has already executed can be stopped when it is determined that the subject vehicle M will not cross the dividing line and determines that automatic lane change assistance control (ALC) which has already executed cannot be stopped when it is determined that the subject vehicle M will cross the dividing line.

The lane change executor 212 stops the actuated turn signal 70 and executes automatic lane change assistance control (ALC) such that the subject vehicle M returns to the center of the own lane L1 from the current position when the lane change permissibility determiner 211 determines that automatic lane change assistance control (ALC) can be stopped. In the figure, Tx represents a period in which automatic lane change assistance control (ALC) for causing the subject vehicle M to change lanes to the left neighboring lane L2 is executed and Ty represents a period in which automatic lane change assistance control (ALC) for causing the subject vehicle M to return to the center of the own lane L1 is executed. On the other hand, the lane change executor 212 may continuously actuate the turn signal 70 and keep executing automatic lane change assistance control (ALC) for causing the subject vehicle M to change lanes to the left neighboring lane L2 when the lane change permissibility determiner 211 determines that automatic lane change assistance control (ALC) cannot be stopped.

### Another Situation in which Automatic Lane Change Assistance Control is Performed

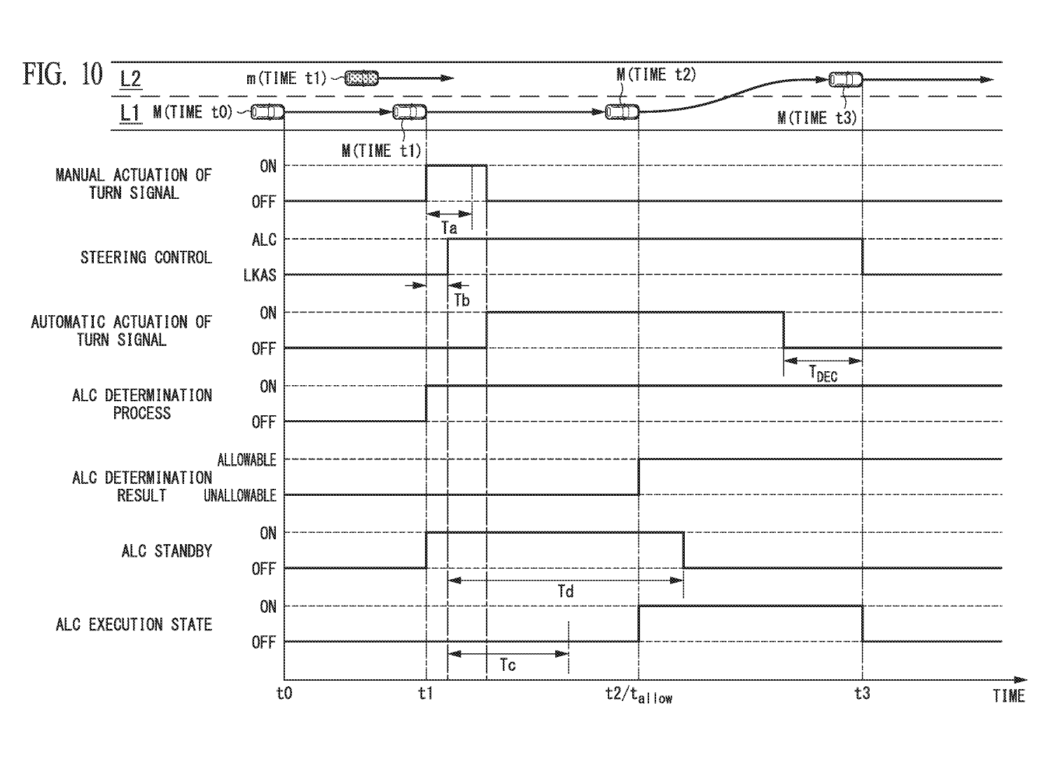

FIG. 10 is a diagram showing a situation in which automatic lane change assistance control is performed together with a timing chart showing a timing of each control. In the example of FIG. 10, the lane change permissibility determiner 211 starts the process of determining whether lane change is allowable when the turn signal lever 40a has shifted to the half-press position P1 (the ALC determination process switches from an OFF state to an ON state) and determines that lane change is allowable at the time t_{allow} at which the counted time is equal to or longer than the third predetermined time Tc and does not reach the fourth predetermined time Td differently from the above-described example.

In the illustrated example, the time elapsed from when the turn signal lever 40a has shifted to the half-press position P1 is equal to or longer than the first predetermined time Ta, and thus the lane change permissibility determiner 211 determines that the operation of the turn signal lever 40a at the time t1 is an operation indicating lane change and permits the turn signal 70 to be continuously actuated. Accordingly, the lane change executor 212 actuates the turn signal 70 (automatic turn signal actuation state switches from an OFF state to an ON state) independently of the operation of the turn signal lever 40a when the turn signal lever 40a returns to the neutral position P0 from the half-press position P1.

In addition, the lane change executor 212 executes automatic lane change assistance control (ALC) at the time t_{allow} because it is determined that lane change is allowable at the time t_{allow} at which the fourth predetermined time Td has not elapsed. Then, the lane change executor 212 stops the automatically actuated turn signal 70 at a time the fifth predetermined time T_{DEC} before time T3 at which completion of lane change is predicted and stops automatic lane change assistance control (ALC) at the time t3 at which lane change to the neighboring lane L2 which is a lane change destination is completed.

### Another Situation in which Automatic Lane Change Assistance Control is not Performed

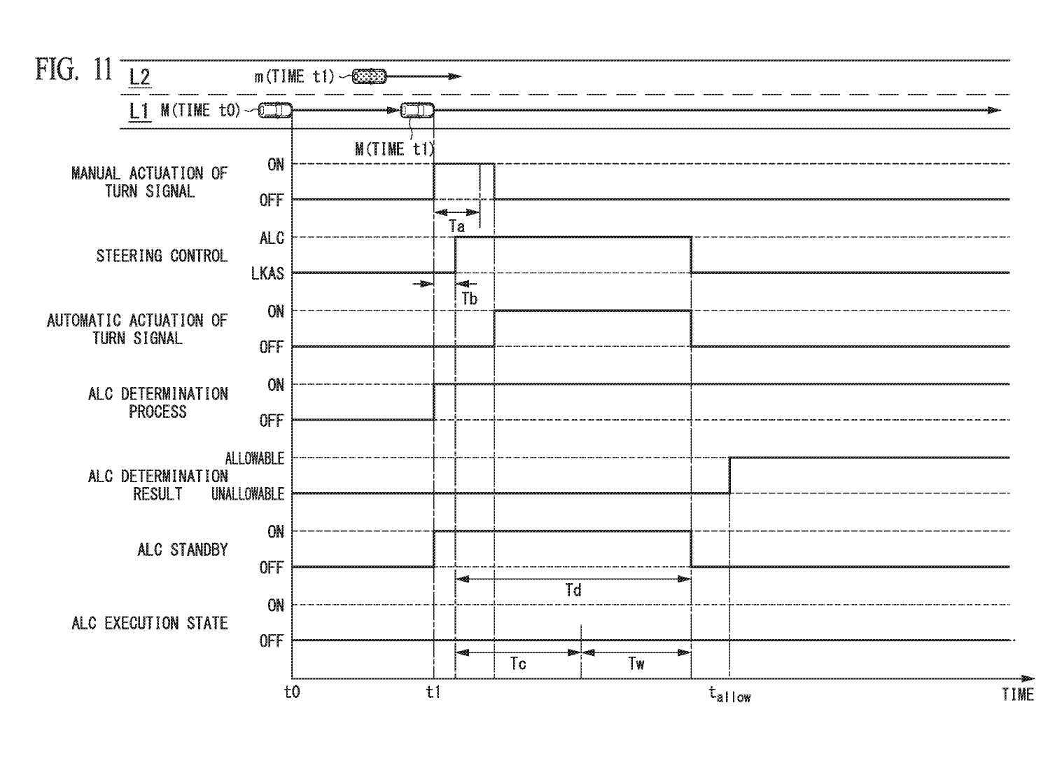

FIG. 11 is a diagram showing a situation in which automatic lane change assistance control is performed together with a timing chart showing a timing of each control. In the example of FIG. 11, the lane change permissibility determiner 211 starts the process of determining whether lane change is allowable when the turn signal lever 40a has shifted to the half-press position P1 (the ALC determination process switches from an OFF state to an ON state). In addition, in the illustrated example, since a neighboring vehicle m exists in the left neighboring lane L2 which is a lane change destination, the lane change permissibility determiner 211 determines that lane change is allowable at the time t_{allow} at which the fourth predetermined time Td has elapsed instead of determining that lane change is allowable before the fourth predetermined time Td elapses from operation of the turn signal lever 40a.

In the illustrated example, the time elapsed from when the turn signal lever 40a has shifted to the half-press position P1 is equal to or longer than the first predetermined time Ta, and thus the lane change permissibility determiner 211 determines that the operation of the turn signal lever 40a at time t1 is an operation indicating lane change and permits the turn signal 70 to be continuously actuated. Accordingly, the lane change executor 212 actuates the turn signal 70 (automatic turn signal actuation state switches from an OFF state to an ON state) independently of the operation of the turn signal lever 40a when the turn signal lever 40a returns to the neutral position P0 from the half-press position P1.

In addition, in the illustrated example, the lane change permissibility determiner 211 does not determine that lane change is allowable before the fourth predetermined time Td elapses from start of time counting and determines that lane change is allowable at the time t_{allow} at which the fourth predetermined time Td has elapsed. Accordingly, automatic lane change assistance control (ALC) in a standby state is stopped without being executed and the automatically actuated turn signal 70 is stopped even after the third predetermined time Tc has elapsed (in a period Tw in the figure). In this case, the lane keeping assistance controller 208 executes lane keeping assistance control (LKAS) instead.

### Another Situation in which Automatic Lane Change Assistance Control is not Performed

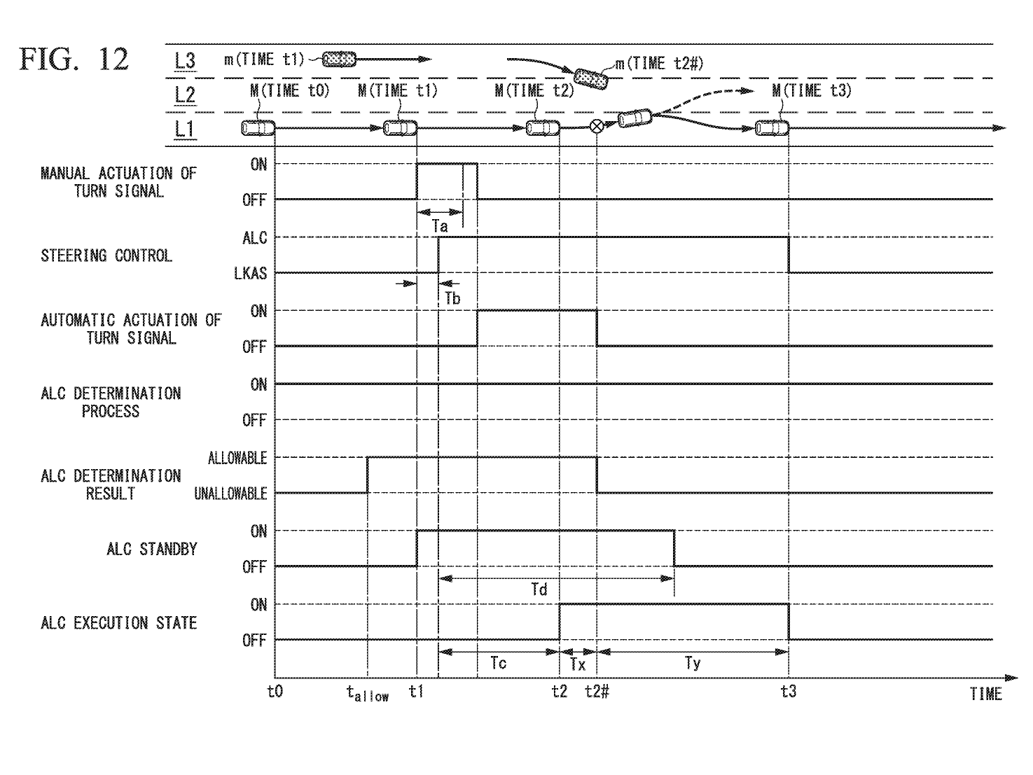

FIG. 12 is a diagram showing a situation in which automatic lane change assistance control is performed together with a timing chart showing a timing of each control. In the example of FIG. 12, the lane change permissibility determiner 211 starts the process of determining whether lane change is allowable when the turn signal lever 40a has shifted to the half-press position P1 (the ALC determination process switches from an OFF state to an ON state). In addition, in the illustrated example, the lane change permissibility determiner 211 determines that lane change is allowable at the time t_{allow} before the turn signal lever 40a or the like is operated although a neighboring vehicle m exists in the left neighboring lane L2 which is a lane change destination.

In the illustrated example, the time elapsed from when the turn signal lever 40a has shifted to the half-press position P1 is equal to or longer than the first predetermined time Ta, and thus the lane change permissibility determiner 211 determines that the operation of the turn signal lever 40a at time t1 is an operation indicating lane change and permits the turn signal 70 to be continuously actuated. Accordingly, the lane change executor 212 actuates the turn signal 70 (automatic turn signal actuation state switches from an OFF state to an ON state) independently of the operation of the turn signal lever 40a when the turn signal lever 40a returns to the neutral position P0 from the half-press position P1.

The outside recognizer 202 recognizes that the neighboring vehicle m existing in the left neighboring lane L2 intends to change lanes to the own lane L1 as an action state of the neighboring vehicle m at time t2. In this case, the lane change permissibility determiner 211 determines that lane change is not newly allowable since the probability that the condition (1) is not satisfied increases at a certain time t2# in the future and determines whether automatic lane change assistance control (ALC) which has already been executed can be stopped. Since it is determined that automatic lane change assistance control (ALC) which has already been executed can be stopped in the illustrated example, the lane change executor 212 stops the actuated turn signal 70 and executes automatic lane change assistance control (ALC) such that the subject vehicle M returns to the center of the own lane L1 from the current position. In this manner, lane change can be appropriately performed on the basis of a current or future state of the neighboring vehicle m existing in a lane which is a lane change destination even when the turn signal lever 40a is operated and lane change indication is not canceled.

### Processing Flow

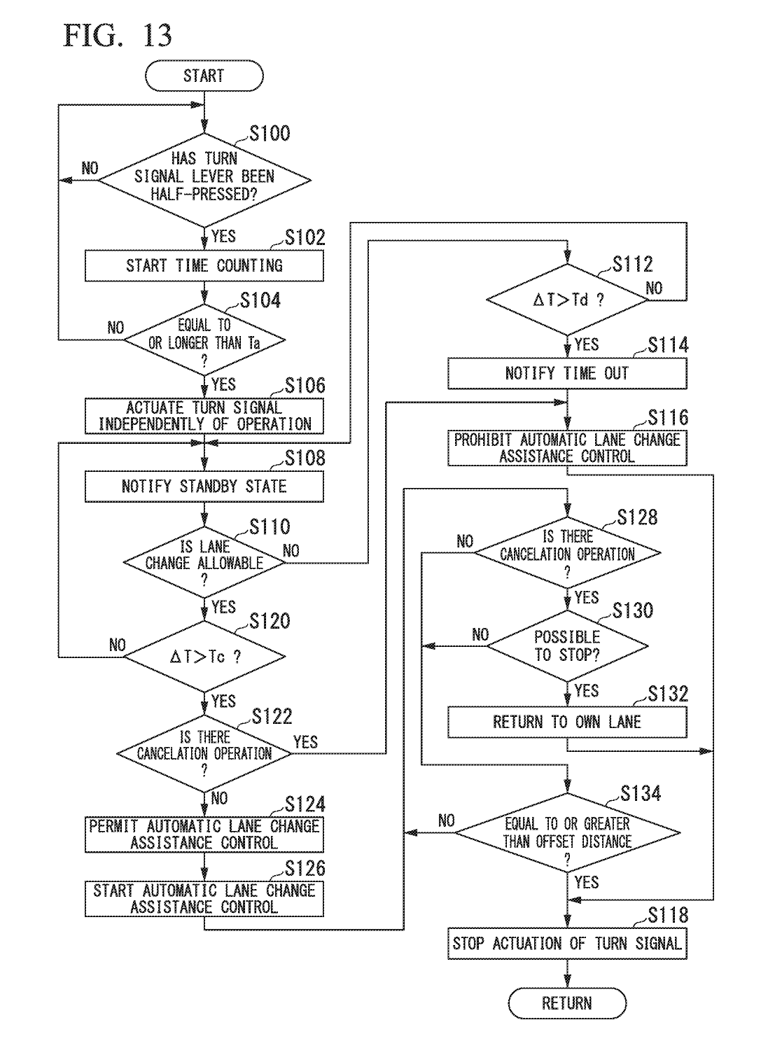

FIG. 13 is a flowchart showing a series of processes performed by the master controller 100 and the driving assistance controller 200. For example, the processes of this flowchart may be repeatedly performed in a predetermined period in the driving assistance mode.

First, the lane change permissibility determiner 211 determines whether the turn signal lever 40a positioned at the neutral position P0 has shifted to the half-press position P1 or P1# on the basis of a detection signal of the lever position detector 40b (step S100).

The lane change permissibility determiner 211 starts time counting when it is determined that the turn signal lever 40a has shifted to the half-press position P1 or P1# (step S102).

Subsequently, the lane change permissibility determiner 211 determines whether a time elapsed from when time counting is started to when the turn signal lever 40a returns to the neutral position P0 is equal to or longer than the first predetermined time Ta (step S104). That is, the lane change permissibility determiner 211 determines whether a time for which an occupant supports the turn signal lever 40a such that the turn signal lever 40a does not return to the neutral position P0 is equal to or longer than the first predetermined time Ta.

When the time elapsed until the turn signal lever 40a returns to the neutral position P0 is shorter than the first predetermined time Ta, the lane change permissibility determiner 211 determines that the operation performed on the turn signal lever 40a in the process of step S100 is not an operation indicating lane change. Then, the lane change permissibility determiner 211 returns the process to step S100 without causing the lane change executor 212 to continuously actuate the turn signal 70.

On the other hand, when the time elapsed until the turn signal lever 40a returns to the neutral position P0 is equal to or longer than the first predetermined time Ta, the lane change permissibility determiner 211 determines that the operation performed on the turn signal lever 40a in the process of step S100 is an operation indicating lane change and permits the lane change executor 212 to continuously actuate the turn signal 70. Accordingly, the lane change executor 212 actuates the turn signal 70 independently of the operation of the turn signal lever 40a at a timing at which the turn signal lever 40a returns to the neutral position P0 from the half-press position P1 or P1# (step S106).

Subsequently, the HMI controller 120 controls the HMI 20 to notify the occupant that lane change indicated by the operation of the turn signal lever 40a stands by without being executed (step S108).

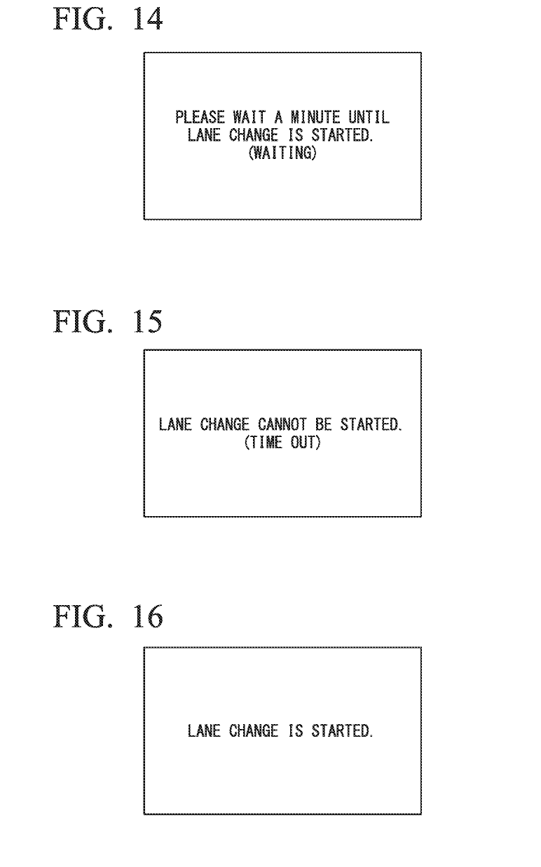

FIG. 14 is a diagram showing an example of an image displayed on a display device of the HMI 20 during standby for lane change. For example, the HMI controller 120 displays the image as illustrated in FIG. 14 on each display device of the HMI 20 to notify the occupant that lane change stands by. In addition, the HMI controller 120 may output a voice and the like through the speaker of the HMI 20 to notify the occupant that lane change stands by. Further, the HMI controller 120 may cause the display device to continuously display an image for notification of lane change in a standby state until the processing flow proceeds to step S114 or step S124 which will be described later.

Subsequently, the lane change permissibility determiner 211 determines whether lane change to a neighboring lane on the side of a turn signal actuated by the operation of the turn signal lever 40a is allowable (step S110). For example, the lane change permissibility determiner 211 determines whether lane change to the left neighboring lane is allowable when the turn signal lever 40a has shifted to the half-press position P1 and determines whether lane change to the right neighboring lane is allowable when the turn signal lever 40a has shifted to the half-press position P1# in the process of step S100.

When it is determined that lane change is not allowable, the lane change permissibility determiner 211 compares a time ΔT elapsed from start of time counting in the process of step S102 to the present time with the fourth predetermined time Td to determine whether the elapsed time ΔT has exceeded the fourth predetermined time Td (Step S112).

When it is determined that the elapsed time ΔT has not exceeded the fourth predetermined time Td, the lane change permissibility determiner 211 returns the process to step S108. Accordingly, determination of whether lane change is allowable is continued until the fourth predetermined time Td elapses from start of time counting.

On the other hand, when the lane change permissibility determiner 211 determines that the elapsed time ΔT has exceeded the fourth predetermined time Td, the HMI controller 120 controls the HMI 20 to notify the occupant that execution of lane change has timed out (step S114).

FIG. 15 is a diagram showing an example of an image displayed on a display device of the HMI 20 during time out. For example, the HMI controller 120 notifies the occupant of time out by switching the image displayed on each display device of the HMI 20 from an image for notification of standby for lane change (refer to FIG. 14, for example) to an image as illustrated in FIG. 15. That is, the HMI controller 120 controls the HMI 20 to stop output of information for notifying standby for lane change and output information for newly notifying time out.

Subsequently, the lane change permissibility determiner 211 prohibits execution of automatic lane change assistance control (step S116). Then, the lane change executor 212 stops automatic lane change assistance control which stands by without being executed. In addition, the lane change executor 212 stops the turn signal 70 actuated through the process of step S106 (step S118).

On the other hand, when it is determined that lane change is allowable in the process of step S110, the lane change permissibility determiner 211 compares the time ΔT elapsed from when time counting is started in the process of step S102 until the present time with the third predetermined time Tc to determine whether the elapsed time ΔT has exceeded the third predetermined time Tc (step S120). When it is determined that the elapsed time ΔT has not exceeded the third predetermined time Tc, the lane change permissibility determiner 211 returns the process to step S108. Accordingly, lane change stands by instead of being executed until the third predetermined time Tc elapses from start of time counting.

On the other hand, when it is determined that the elapsed time ΔT has exceeded the third predetermined time Tc, the lane change permissibility determiner 211 determines whether an operation for canceling the previous operation performed on the turn signal lever 40a has been performed (step S122). For example, when the turn signal lever 40a has shifted to the half-press position P1 in the process of step S100 and the turn signal lever 40a has shifted to the half-press position P1# in the process of step S122, the lane change permissibility determiner 211 determines that the operation performed on the turn signal lever 40a in the process of step S122 is an operation for canceling the operation performed on the turn signal lever 40a in the process of step S100. In this case, the lane change permissibility determiner 211 proceeds the process to step S116.

On the other hand, when the turn signal lever 40a is not operated or has shifted to the same position as the previous position after the process of step S100, the lane change permissibility determiner 211 determines that an operation for cancelling the previous operation performed on the turn signal lever 40a has not been performed. In this case, the lane change permissibility determiner 211 permits execution of automatic lane change assistance control (step S124). Then, the lane change executor 212 starts automatic lane change assistance control which stands by instead of being executed (step S126). Here, the HMI controller 120 controls the HMI 20 to notify the occupant that lane change starts.

FIG. 16 is a diagram showing an example of an image displayed on a display device of the HMI 20 when automatic lane change assistance control starts. For example, the HMI controller 120 notifies the occupant that lane change starts by switching the image displayed on each display device of the HMI 20 from an image for notification of standby for lane change (refer to FIG. 14, for example) to an image as illustrated in FIG. 16. In addition, the HMI controller 120 may notify the occupant that lane change starts by outputting a voice and the like from the speaker of the HMI 20.

Subsequently, the lane change permissibility determiner 211 determines whether an operation for canceling the previous operation performed on the turn signal lever 40a has been performed while the lane change executor 212 executes automatic lane change assistance control (step S128).

When it is determined that an operation for canceling the previous operation performed on the turn signal lever 40a has been performed, the lane change permissibility determiner 211 determines whether automatic lane change assistance control which has already been executed can be stopped (step S130).

When the lane change permissibility determiner 211 determines that automatic lane change assistance control can be stopped, the lane change executor 212 executes automatic lane change assistance control such that the subject vehicle M returns to the center of the own lane from the current position (step S132) and stops the actuated turn signal 70. Further, the lane change executor 212 may actuate a turn signal 70 on a side (lane center side when viewed from the subject vehicle M) opposite to the turn signal 70 after the actuated turn signal 70 is stopped.

On the other hand, when the lane change permissibility determiner 211 determines that automatic lane change assistance control cannot be stopped, the lane change executor 212 continues automatic lane change assistance control for lane change to a neighboring lane.

Subsequently, the lane change executor 212 compares a distance to the center of the neighboring lane which is a lane change destination with the offset distance D_{DEC} to determine whether the distance to the center of the neighboring lane has become equal to or longer than the offset distance D_{DEC} (step S134). When the distance to the center of the neighboring lane is less than the offset distance D_{DEC}, the lane change executor 212 returns the process to step S128. Accordingly, the lane change permissibility determiner 211 continues determination of whether an operation for canceling a lane change indication operation has been performed.

On the other hand, when the distance to the center of the neighboring lane is equal to or longer than the offset distance D_{DEC}, the lane change executor 212 proceeds the process to step S118 to stop the actuated turn signal 70. Accordingly, the processes of the present flowchart end.

Although the lane change executor 212 continuously actuates the turn signal 70 until a time the fifth predetermined time T_{DEC} before a time at which completion of lane change is predicted even when the turn signal lever 40a has been continuously half-pressed for the first predetermined time Ta or longer and has shifted to the original neutral position P0 at a certain timing after the first predetermined time Ta has elapsed or the turn signal lever substitute switch 20c has been continuously operated for the first predetermined time Ta or longer and was not operated at a certain timing after the first predetermined time Ta has elapsed in the above-described embodiment, the present invention is not limited thereto. For example, the lane change executor 212 may continuously actuate the turn signal 70 until a time the fifth predetermined time T_{DEC} before a time at which completion of lane change is predicted even when the turn signal lever 40a has returned to the original neutral position P0 after the first predetermined time Ta has elapsed from when the turn signal lever 40a has shifted to the full-press position P2 or P2#.

According to the above-described embodiment, the turn signal lever 40a (receiver) which receives an operation of an occupant of a vehicle and shifts to any one of a plurality of positions including the neutral position P0 (first state) and the half-press position P1 or P1# (second state) according to the received operation, the turn signal 70 actuating when the turn signal lever 40a has shifted to the half-press position P1 or P1# from the neutral position P0, and the lane change assistance controller 210 which executes automatic lane change assistance control (ALC) according to shifting of the turn signal lever 40a from the neutral position P0 to the half-press position P1 or P1# are provided, and the turn signal 70 may be actuated for an appropriate time during lane change because the turn signal 70 is continuously actuated until the execution state of automatic lane change assistance control (ALC) switches to a predetermined state even after the turn signal lever 40a has returned to the neutral position P0 from any half-press position when the lane change assistance controller 210 executes automatic lane change assistance control (ALC).

In addition, according to the above-described embodiment, an actuation time of the turn signal 70 after the turn signal lever 40a has returned to the neutral position P0 from any half-press position is determined on the basis of the execution state of automatic lane change assistance control (ALC), and thus the turn signal 70 may be actuated for a time more appropriately during lane change.

For example, since the lane change assistance controller 210 continuously actuates the turn signal 70 until the subject vehicle M reaches the offset distance D_{DEC} set on the basis of the center of a neighboring lane or the present time reaches a time the fifth predetermined time T_{DEC} before a time at which completion of lane change is predicted, it is possible to continuously output a sign for lane change to neighboring vehicles until at least the subject vehicle M crosses a dividing line and to match a timing at which the occupant feels completion of lane change of the subject vehicle M with a timing at which the system determines that lane change is completed. As a result, when actuation of the turn signal 70 is not stopped irrespective of completion of lane change, the occupant need not stop the turn signal 70 and thus the burden of an operation of stopping the turn signal 70 for the occupant can be eliminated.

Furthermore, according to the above-described embodiment, when the turn signal lever 40a is continuously positioned at any half-press position for the first predetermined time Ta or longer, the turn signal 70 is continuously actuated and automatic lane change assistance control (ALC) is executed. Accordingly, it is possible to restrain lane change from starting when the turn signal lever 40a has temporarily shifted to a half-press position due to an erroneous operation.

Moreover, according to the above-described embodiment, execution of automatic lane change assistance control (ALC) is stopped when the turn signal lever 40a has been continuously positioned at any half-press position for the first predetermined time Ta or longer and then shifted to the half-press position on the opposite side, and thus it is possible to perform lane change in which the intention of the occupant has been sufficiently reflected.

Further, according to the above-described embodiment, execution of automatic lane change assistance control (ALC) is stopped when the subject vehicle M does not cross a dividing line dividing a lane which is a lane change destination and a lane before lane change, and thus it is possible to stop lane change in further consideration of neighboring vehicles traveling in the lane which is a lane change destination.

### Modified Example of Embodiment

Hereinafter, a modified example of the embodiment will be described. In the above-described embodiment, whether lane change stands by, is prohibited or is started is determined according to whether the time Δt elapsed from when the turn signal lever 40a is operated has passed the third predetermined time Tc or the fourth predetermined time Td. On the other hand, in the modified example of the embodiment, a travel distance of the subject vehicle M from when the turn signal lever 40a is operated is measured and whether lane change stands by, is prohibited or is started is determined according to whether the measured distance is equal to or greater than a first predetermined distance or a second predetermined distance. The second predetermined distance is set to be longer than the first predetermined distance. The first predetermined distance is a distance set to inform neighboring vehicles of the intention of lane change of the subject vehicle M like the third predetermined time Tc.

For example, in the modified example of the embodiment, the processes of the flowchart of the above-described embodiment may be applied by substituting the third predetermined time Tc with the first predetermined distance and substituting the fourth predetermined time Td with the second predetermined distance. Accordingly, the lane change assistance controller 210 determines a lane change start timing on the basis of whether the subject vehicle M has traveled the first predetermined distance (distance corresponding to the third predetermined time Tc) from when the turn signal lever 40a has shifted to any half-press position and thus it is possible to cause execution of lane change to stand by until the subject vehicle M travels the second predetermined distance and execute lane change at a time when the subject vehicle M has traveled the first predetermined distance even when the turn signal 70 is actuated and conditions for starting lane change has been satisfied, for example, in the modified example of the embodiment.

In addition, although it is determined that the operation performed on the turn signal lever 40a is an operation indicating lane change when the position of the turn signal lever 40a is maintained for the first predetermined time Ta or longer after the turn signal lever 40a has been positioned at the half-press position P1 or P1# in the above-described embodiment, the present invention is not limited thereto.

For example, when the half-press position P1 or Pl# is maintained even when a sixth predetermined time Te longer than the first predetermined time Ta or longer has elapsed from when the turn signal lever 40a has been positioned at the half-press position P1 or P1#, the lane change permissibility determiner 211 determines that the operation performed on the turn signal lever 40a is not an operation indicating lane change. Then, the lane change permissibility determiner 211 prohibits continuous actuation of the turn signal 70. In this case, the lane change executor 212 does not automatically actuate the turn signal 70 even if the turn signal lever 40a returns to the neutral position P0 from the half-press position.

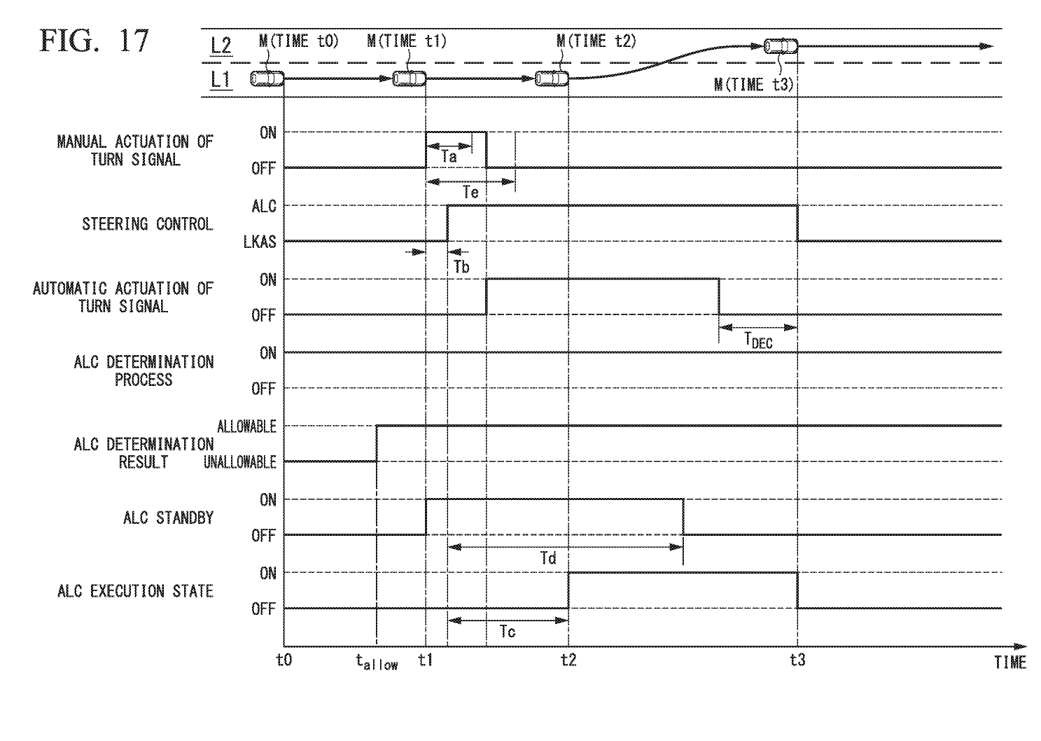

FIG. 17 is a diagram showing a situation in which automatic lane change assistance control is performed together with a timing chart showing a timing of each control. In the example of FIG. 17, the lane change permissibility determiner 211 determines that lane change is allowable at time t_{allow} before the turn signal lever 40a or the turn signal lever substitute switch 20c is operated as in the above-described example.

In the illustrated example, the time elapsed from when the turn signal lever 40a has shifted to the half-press position P1 is equal to or longer than the first predetermined time Ta and shorter than the sixth predetermined time Te, and thus the lane change permissibility determiner 211 determines that the operation of the turn signal lever 40a at time t1 indicates lane change and permits the turn signal 70 to be actuated. Accordingly, the lane change executor 212 automatically actuates the turn signal 70 (automatic turn signal actuation state switches from an OFF state to an ON state) independently of the operation of the turn signal lever 40a when the turn signal lever 40a returns to the neutral position P0 from the half-press position P1.

In addition, since it has been determined that lane change is allowable before time counting is started, the lane change executor 212 waits execution of automatic layer change assistance control (ALC) until the third predetermined time Tc elapses and starts automatic lane change assistance control (ALC) at a time (t1+Tb+Tc) at which the third predetermined time Tc has passed.

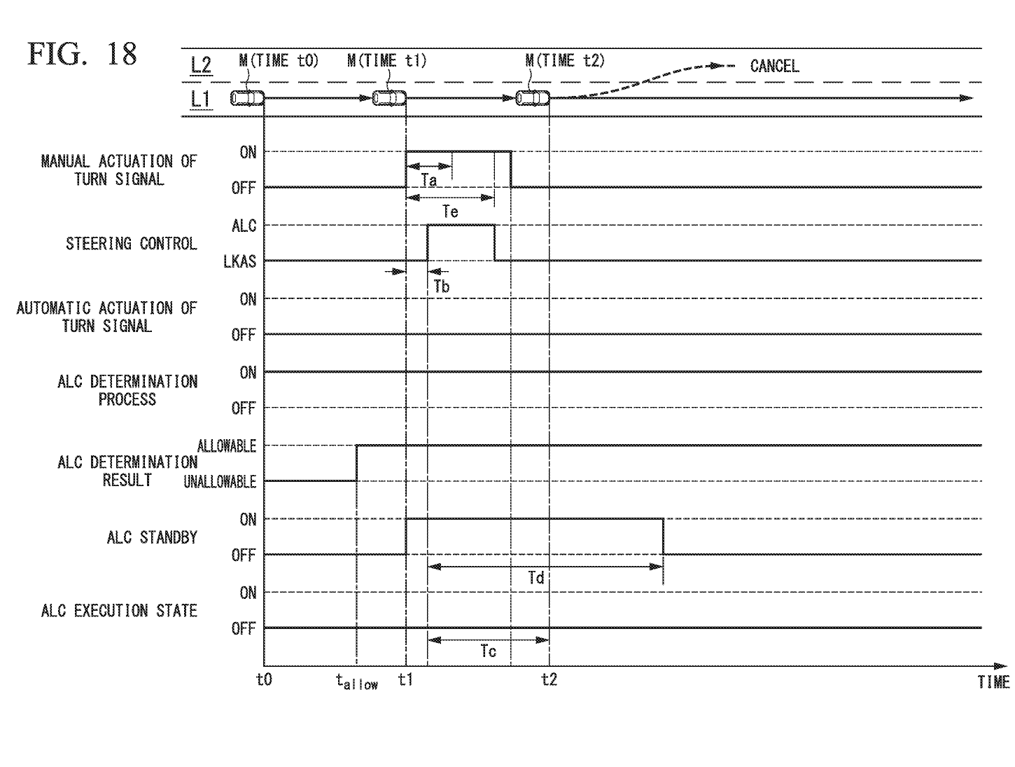

FIG. 18 is a diagram showing a situation in which automatic lane change assistance control is not performed together with a timing chart showing a timing of each control. In the example of FIG. 18, the lane change permissibility determiner 211 determines that lane change is allowable at time t_{allow} before the turn signal lever 40a or the turn signal lever substitute switch 20c is operated as in the above-described example.

In the example, the time elapsed from when the turn signal lever 40a has shifted to the half-press position P1 is equal to or longer than the sixth predetermined time Te, and thus the lane change permissibility determiner 211 determines that the operation of the turn signal lever 40a at time t1 is not an operation indicating lane change and prohibit actuation of the turn signal 70. Then, the lane change executor 212 does not automatically actuate the turn signal 70 and cancels automatic lane change assistance control (ALC) without executing it, and the lane keeping assistance controller 208 continues lane keeping assistance control (LKAS) instead (automatic turn signal actuation state is maintained in an OFF state).

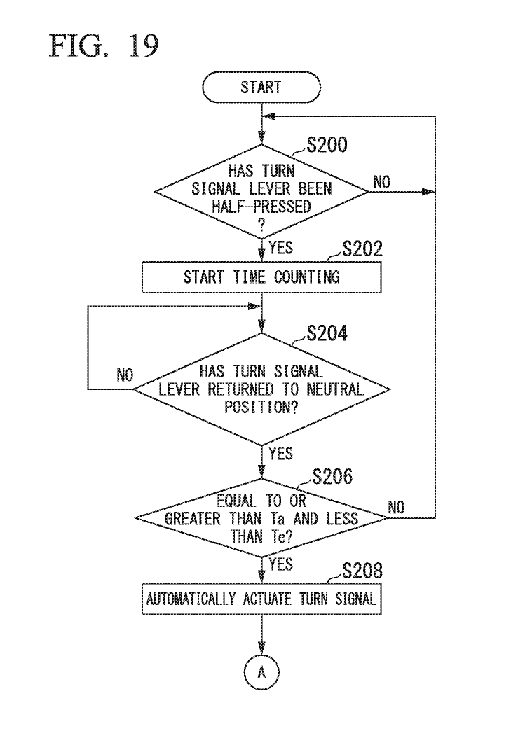

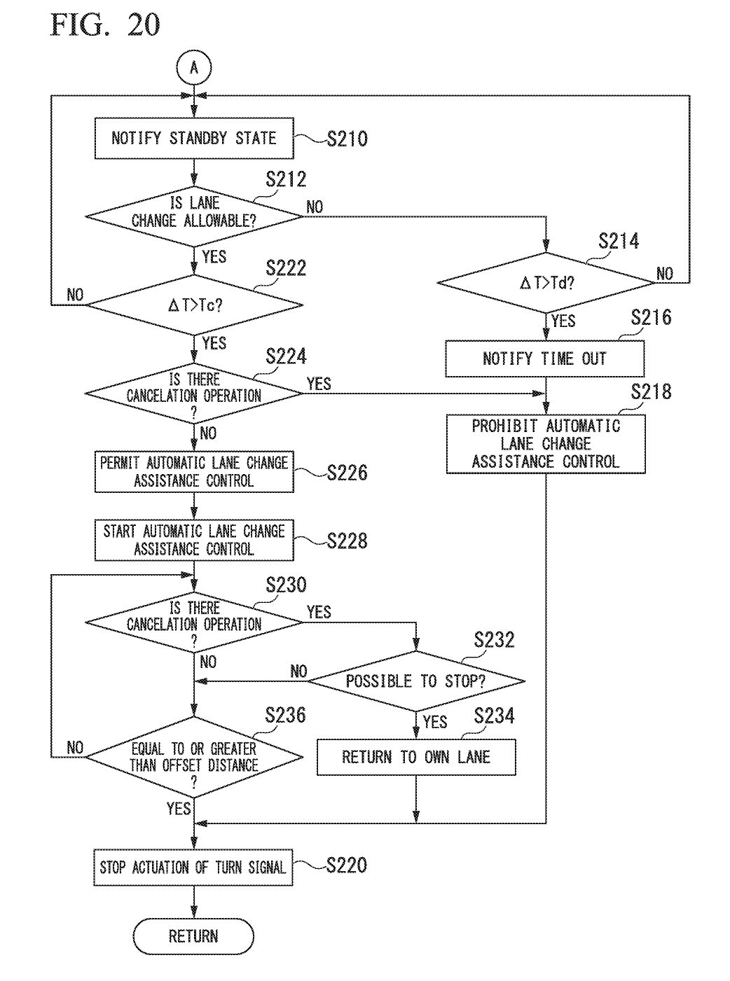

FIGS. 19 and 20 are flowcharts showing another example of a series of processes performed by the master controller 100 and the driving assistance controller 200. For example, the processes of these flowcharts may be repeatedly performed in a predetermined period in the driving assistance mode.

First, the lane change permissibility determiner 211 determines whether the turn signal lever 40a positioned at the neutral position P0 has shifted to the half-press position P1 or P1# on the basis of a detection signal of the lever position detector 40b (step S200).

The lane change permissibility determiner 211 starts time counting when it is determined that the turn signal lever 40a has shifted to the half-press position P1 or P1# (step S202).

Subsequently, the lane change permissibility determiner 211 determines whether the turn signal lever 40a positioned at any half-press position has returned to the neutral position P0 (step S204).

When it is determined that the turn signal lever 40a has returned to the neutral position P0, the lane change permissibility determiner 211 determines whether the counted time is equal to or longer than the first predetermined time Ta and shorter than the sixth predetermined time Te (step S206).

When it is determined that the counted time is shorter than the first predetermined time Ta or equal to or longer than the sixth predetermined time Te, the lane change permissibility determiner 211 determines that the operation performed on the turn signal lever 40a in the process of step S200 is not an operation indicating lane change. Then, the lane change permissibility determiner 211 does not cause the lane change executor 212 to continue actuation of the turn signal 70 and returns the process to step S200.

On the contrary, when it is determined that the counted time is equal to or longer than the first predetermined time Ta and shorter than the sixth predetermined time Te, the lane change permissibility determiner 211 determines that the operation performed on the turn signal lever 40a in the process of step S200 is an operation indicating lane change and permits the lane change executor 212 to continuously actuate the turn signal 70. Then, the lane change executor 212 automatically actuates the turn signal 70 independently of operation of the turn signal lever 40a at a timing at which the turn signal lever 40a returns to the neutral position P0 from the half-press position P1 to P1# (step S208).

The following processes of step S210 to S236 are the same as the above-described processes of steps S108 to S134 and thus description thereof is omitted. According to such processes, when an operation performed on the turn signal lever 40a is continued for a certain time (the sixth predetermined time Te) or longer, it is possible to determine that the operation is an operation for the turn signal lever 40a performed when manual lane change or the like is executed instead of an operation indicating automatic lane change assistance control (ALC). As a result, when an operation of the turn signal lever 40a is not an operation for intending indication of automatic lane change assistance control (ALC), the turn signal 70 is not turned until the fourth predetermined time Td elapses after the first predetermined time Ta has elapsed, and the turn signal 70 can be automatically turned on more accurately according to automatic lane change assistance control (ALC) intended by the occupant.

In addition, although the lane change permissibility determiner 211 determines that an operation performed on the turn signal lever 40a is not an operation indicating lane change on condition that the half-press position P1 or P1# is maintained even when the sixth predetermined time Te longer than the first predetermined time Ta or longer elapses from when the turn signal lever 40a is positioned at the half-press position P1 or P1# in the above-described modified example, the present invention is not limited thereto. For example, the lane change permissibility determiner 211 may determine that an operation performed on the turn signal lever 40a is not an operation indicating lane change on condition that the full-press position P2 or P2# is maintained even when the sixth predetermined time Te or longer elapses from when the turn signal lever 40a is positioned at the full-press position P2 or P2# or the turn signal lever substitute switch 20c is operated after the sixth predetermined time Te or longer elapses. In addition, when the turn signal 70 is a so-called one-touch turn signal, the lane change permissibility determiner 211 may also determine that an operation performed on the turn signal lever 40a is not an operation indicating lane change on condition that the turn signal lever 40a is operated for the sixth predetermined time Te or longer.

Furthermore, when it is necessary to perform lane change for traveling a route planned through the automated driving system, such as an event of passing a vehicle which is traveling in front of the subject vehicle M at a lower speed than the subject vehicle M, an event of changing a course of the subject vehicle M to a branched road or a joint road when the subject vehicle M travels along a preset path, and the like, the present invention is also applicable when an occupant operates the turn signal lever 40a or the turn signal lever substitute switch 20c according to such events.

The above-described embodiment may be represented as follows.

A vehicle control system, including:

a receiver which receives an operation of an occupant of a vehicle and, according to the received operation, changes to any one of a plurality of states including a first state before an operation is received and a second state after the operation is received;

a direction indicator which is actuated when the receiver has changed to the second state;

a storage which stores a program; and

a processor,

wherein the processor is configured to execute lane change control for changing lanes of the vehicle to other lanes independently of a steering operation of the occupant of the vehicle according to change of the receiver from the first state to the second state by executing the program, and to cause the direction indicator to be continuously actuated until the execution situation of the lane change control becomes to a predetermined situation even after the receiver has changed from the second state to the first state when the lane change control is executed.

While embodiments of the present invention have been described above, the present invention is not limited to such embodiments and various modifications and substitutions can be made without departing from the spirit or scope of the present invention.

What is claimed is:

1. A vehicle control system, comprising:
a receiver which receives an operation of an occupant of a vehicle and, according to the received operation, changes to any one of a plurality of states including a first state before an operation is received and a second state after the operation is received;
a direction indicator which is actuated when the receiver has changed to the second state; and
a lane change controller which executes lane change control for changing lanes of the vehicle to other lanes independently of a steering operation of the occupant of the vehicle according to change of the receiver from the first state to the second state,
wherein the lane change controller continuously actuates the direction indicator until the execution situation of the lane change control becomes a predetermined situation even after the receiver has changed from the second state to the first state when the lane change control is executed.

2. The vehicle control system according to claim 1, wherein the lane change controller further determines an actuation time of the direction indicator after the receiver has changed from the second state to the first state on the basis of the execution situation of the lane change control.

3. The vehicle control system according to claim 1, wherein the direction indicator is continuously actuated while the receiver is in the second state and is not actuated when the receiver changes from the second state to the first state.

4. The vehicle control system according to claim 1, wherein the direction indicator is continuously actuated for a predetermined time even after the receiver has changed to the first state from the second state.

5. The vehicle control system according to claim 1, wherein the lane change controller continuously actuates the direction indicator until the vehicle arrives at a predetermined position which is a lane change destination or a time necessary for the vehicle to arrive at a predetermined position which is a lane change destination elapses even after the receiver has changed to the first state from the second state.

6. The vehicle control system according to claim 1, wherein, when the receiver which has changed to the second state from the first state is maintained in the second state for a first predetermined time or longer, the lane change controller continuously actuates the direction indicator until the execution situation of the lane change control becomes a predetermined situation even after the receiver has changed to the first state from the second state.

7. The vehicle control system according to claim 6, wherein, when the receiver which has been in the second state for the first predetermined time or longer changes to the second state again after changing to the first state from the second state and lane change control expected to be started according to the first change to the second state of the receiver has not been executed yet, the lane change controller further stops the expected lane change control without starting the expected lane change control.

8. The vehicle control system according to claim 6, wherein, when the receiver which has been in the second state for the first predetermined time or longer changes to the second state again after changing to the first state from the second state and the lane change control has already been executed according to the first change to the second state of the receiver, the lane change controller further stops the lane change control being executed if the vehicle does not cross a dividing line dividing a lane of a lane change destination and a lane before lane change.

9. The vehicle control system according to claim 6, wherein the second state includes a third state in which a direction indicator provided on the left side when viewed in the advancing direction of the vehicle is actuated and a fourth state in which a direction indicator provided on the right side when viewed in the advancing direction of the vehicle is actuated, and the lane change controller stops the lane change control when the receiver has changed to the fourth state after changing to the first state from the third state or the receiver has changed to the third state after changing to the first state from the fourth state.

10. A vehicle control method which causes a computer mounted in a vehicle including a receiver which receives an operation of an occupant and, according to the received operation, changes to any one of a plurality of states including a first state before an operation is received and a second state after the operation is received and a direction indicator which is actuated when the receiver has changed to the second state to execute lane change control for changing lanes of the vehicle to other lanes independently of a steering operation of the occupant of the vehicle according to change of the receiver from the first state to the second state and to continuously actuate the direction indicator until the execution situation of the lane change control becomes a predetermined situation even after the receiver has changed from the second state to the first state when the lane change control is executed.
